(19) United States
(12) Patent Application Publication
(10) Pub. No.: US 2002/0010637 A1
(43) Pub. Date: Jan. 24, 2002

(54) Techniques to facilitate shopping for projects

(76) Inventors: Sun Ming Lieu, Los Altos, CA (US); Thomas P. Maliska, Palo Alto, CA (US); Donald Yee, Danville, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/780,987

(22) Filed: Feb. 9, 2001

Related U.S. Application Data
(63) Continuation-in-part of application No. 09/502,863, filed on Feb. 11, 2000.
(60) Provisional application No. 60/181,666, filed on Feb. 11, 2000.

(51) Int. Cl. G06F 17/60

(52) U.S. Cl. 705/26

(57) ABSTRACT

Techniques for purchasing items related to one or more projects. A user may specify a project, and based on information related to the project, the present invention determines purchasable units corresponding to items described in the project. Information related to the purchasable units may be provided to the user allowing the user to purchase one or more purchasable units.

### CROSS-REFERENCES TO RELATED APPLICATIONS

This application claims priority from the following applications, the entire disclosures of which are herein incorporated by reference for all purposes:

(1) U.S. Provisional Patent Application No. 60/181,666 (Attorney Docket No. 20004-000700US), entitled “SYSTEM AND METHOD FOR FACILITATING ELECTRONIC COMMERCE ACTIVITIES” filed Feb. 11, 2000; and

(2) U.S. patent application Ser. No. 09/502,863 (Attorney Docket No. 20004-000800US), entitled “SYSTEM AND METHOD FOR FACILITATING ONLINE SHOPPING ACTIVITIES” filed Feb. 11, 2000.

The present application also incorporates herein by reference for all purposes the entire disclosure of U.S. patent application No. ______ (Attorney Docket No. 20004-000710US), entitled “A TOKENS-BASED SYSTEM FOR PROVIDING INFORMATION TO USERS” filed concurrently with this application.

### BACKGROUND OF THE INVENTION

The present invention relates generally to the field of electronic commerce and more particularly to techniques for improving a user's online shopping experience by enabling a user to purchase items related to one or more user-selected projects in an automated manner.

As a result of the widespread usage and popularity of communication networks, such as the Internet, electronic commerce has blossomed into a multi-billion dollar marketplace for both consumers and vendors alike in recent years. A wide variety of items (including products and/or services) can now be obtained or purchased by consumers via online transactions.

The World Wide Web (the “Web”) has further enabled users of the Internet to participate in commercial transactions from the comfort of their homes or offices. In the Web environment, information resources available via communication networks such as the Internet are typically stored in the form of hypertext documents called “web pages” which can be accessed by users of the Web. A web page may incorporate any combination of text, graphics, audio and video content, software programs, and other data. Web pages may also contain hypertext links to other web pages. Web pages are typically stored on web servers provided by content providers coupled to the Internet. Each web page is uniquely identified by an address called a Uniform Resource Locator (URL) that enables users to access the web page.

Users typically access and view web pages using a program called a “web browser” which may execute on a computer system coupled to the Internet. Users provide URL information to the browser, either directly or indirectly, and the browser responds by retrieving one or more web pages from the Internet corresponding to the URL information. The retrieved web page may then be displayed on the user's computer. Examples of browsers include the Internet Explorer browser program provided by Microsoft Corporation, and the Netscape Navigator browser provided by AOL Corporation, and others.

Using conventional online shopping systems, in order to perform an online purchase, a user generally has to first access a particular vendor's web-site, browse one or more web pages displaying the vendor's online product/item catalog, select one or more purchasable items for purchase from the vendor's product catalog (e.g. by adding the item to a “shopping cart”), and consummate the purchase of the selected purchasable items by authorizing payment, usually via a credit card. Accordingly, in a conventional online shopping environment, the user has to specifically identify and select each item to be purchased.

The item-by-item approach of conventional shopping systems however can be very time consuming and inefficient when a user wishes to purchase a plurality of items related to one or more projects e.g. purchasing ingredients of a food recipe, purchasing components for building a tree-house, etc. For example, lets assume that the user is interested in purchasing all ingredients related to or specified by a particular food recipe. Using conventional online shopping techniques, for each ingredient of the recipe, the user would have to access a particular vendor's online catalog and select a purchasable item corresponding to the ingredient. This process can be very time consuming and frustrating for the user especially when the recipe contains many ingredients. The problem is further compounded when the ingredients have to be purchased from different online vendors.

In light of the above, there is a need for techniques which allow users to purchase items related to one or more projects in a quick and efficient manner.

### SUMMARY OF THE INVENTION

The present invention provides techniques which allow a user to purchase items related to one or more projects in an efficient manner. The user may specify a project, and based on information related to the project, the present invention determines purchasable units corresponding to items described in the project. Information related to the purchasable units may be provided to the user allowing the user to purchase one or more purchasable units.

According to an embodiment of the present invention, the present invention stores first mapping information for a first plurality of items, the first mapping information identifying a first plurality of purchasable units associated with items in the first plurality of items. The embodiment of the present invention receives a purchase request comprising information related to a first project from a computer system, determines a second plurality of items from the information related to the first project, the second plurality of items included in the first plurality of items, determines a second plurality of purchasable units corresponding to the second plurality of items based upon the first mapping information, and communicates information related to the second plurality of purchasable units to the computer system.

According to another embodiment, the present invention stores first mapping information for a first plurality of items, the first mapping information identifying a first plurality of purchasable units corresponding to the first plurality of items. The present invention receives a purchase request comprising information related to a first project and a second project from a computer system, determines a second plurality of items from the information related to the first project, the second plurality of items included in the first plurality of items, determines a third plurality of items from the information related to the second project, the third plurality of items included in the first plurality of items, determines a fourth plurality of items including items from the second plurality of items and the third plurality of items, determines a second plurality of purchasable units corresponding to the fourth plurality of items based upon the first mapping information, and communicates information related to the second plurality of purchasable units to the computer system.

According to yet another embodiment, the present invention stores an information model comprising information for a first plurality of items, the information describing attributes of the first plurality of items, substitute items for the first plurality of items, and hierarchical relationships between the items in the first plurality of items. The embodiment also stores first mapping information for the first plurality of items, the first mapping information identifying a first plurality of purchasable units associated with items in the first plurality of items. The embodiment of the present invention receives a purchase request comprising information related to the first project from a computer system, determines a second plurality of items from the information related to the first project, the second plurality of items included in the first plurality of items, determines a second plurality of purchasable units corresponding to the second plurality of items based upon the information stored by the information model and the first mapping information, and communicates information related to the second plurality of purchasable units to the computer system.

According to another embodiment, the present invention provides facilities for accessing a web page displaying information related to the project, generating a purchase request based upon the information related to the project, in response to the purchase request, receiving information related to a plurality of purchasable units, the plurality of purchasable units corresponding to a plurality of items described by the information related to the project, and selecting at least one purchasable unit from the plurality of purchasable units for purchase.

The foregoing, together with other features, embodiments, and advantages of the present invention, will become apparent when referring to the following specification, claims, and accompanying drawings.

### BRIEF DESCRIPTION OF THE DRAWINGS

FIG. 1 is a simplified block diagram of a distributed computer network which may incorporate an embodiment of the present invention;

FIG. 2 is a simplified block diagram of an exemplary computer system according to an embodiment of the present invention;

FIG. 3 is a simplified high-level flowchart depicting processing performed according to an embodiment of the present invention;

FIG. 4 is a high level simplified flowchart depicting processing for configuring a taxonomy according to an embodiment of the present invention;

FIG. 5 depicts tables which may be used to store information related to items in a taxonomy according to an embodiment of the present invention;

FIG. 6 depicts a data structure which may be used to represent a node in a tree structure according to an embodiment of the present invention;

FIG. 7 depicts a sub-tree of a taxonomy tree structure storing hierarchy relationship information for eggs according to an embodiment of the present invention;

FIG. 8 depicts a mapping of item_ids to purchase units according to an embodiment of the present invention;

FIG. 9 depicts a mapping of project_ids to item_ids according to an embodiment of the present invention;

FIG. 10 is a simplified high-level flowchart showing processing performed for determining purchasable units for projects according to an embodiment of the present invention;

FIG. 11 depicts a web page displaying information related to a project according to an embodiment of the present invention;

FIG. 12 depicts a web page for displaying purchasable units information to a user according to an embodiment of the present invention; and

FIG. 13 is a simplified block diagram showing the various modules/engines of SSPS which may be used to process a purchase request related to project(s) according to an embodiment of the present invention.

### DESCRIPTION OF THE SPECIFIC EMBODIMENTS

The present invention provides techniques for enhancing a user's online shopping experience. Embodiments of the present invention also allow users to purchase items related to one or more user-specified projects in an efficient manner. The term “item” may refer to a good or a service. According to an embodiment of the present invention, a user can purchase items related to one or more projects by simply providing information identifying the projects. Unlike conventional online shopping systems, the user is not required to identify the individual items of a project. Furthermore, the user does not have to access online product catalogs of vendors to make the purchases. In accordance with the present invention, items described in projects identified by a user are mapped to purchasable units (also referred to as purchasable items). In general, the term “purchasable item” or “purchasable unit” may refer to items which can be purchased by a user, e.g. items displayed by a vendor's product/item catalog. Information related to the purchasable units is then provided to the user allowing the user to purchase the purchasable units.

In general, unless stated otherwise, the term “project” as used in this application may refer to a particular task, activity, or undertaking of interest to a user which may involve materials, tools, ingredients, directions, and the like. A project may involve the purchase or one or more items required to complete the project. Examples of projects include preparing a food dish according to a recipe, building a computer, building a house, repairing a faucet, and others. Projects may be related to various areas of domain such as food recipes (e.g. preparing a dish based upon a food recipe), computers (e.g. building a computer), construction (e.g. building a house, repairing a faucet), and the like. While the present invention has been described using projects (i.e. preparing food dishes based upon food recipes) related to the food recipe/items domain, it should however be apparent that the scope of the present invention, as recited in the claims, also extends to other projects from various other domains.

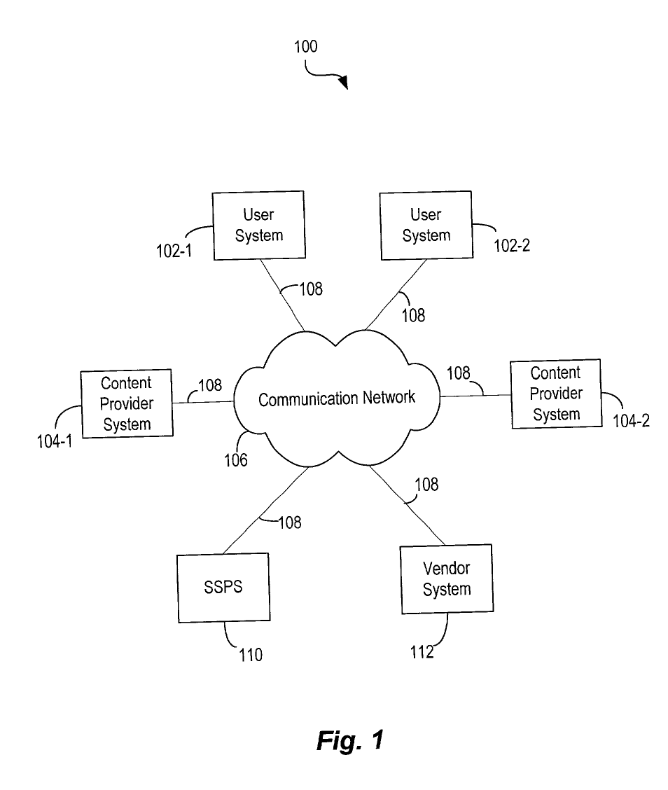

FIG. 1 is a simplified block diagram of a distributed computer network 100 which may incorporate an embodiment of the present invention. Computer network 100 may comprise a plurality of computer systems coupled to a communication network 106 via a plurality of communication links 108. The computer systems may include one or more user systems 102, a vendor system 112, one or more content provider systems 104, and a shopping services provider system (SSPS) 110. Distributed computer network 100 depicted in FIG. 1 is merely illustrative of an embodiment incorporating the present invention and does not limit the scope of the invention as recited in the claims. One of ordinary skill in the art would recognize other variations, modifications, and alternatives. It should be apparent that a computer system coupled to communication network 106 may be used as a user system, a vendor system, a SSPS, a content provide system, or combinations thereof.

Communication network 106 provides a mechanism for allowing the various components of computer network 100 to communicate and exchange information with each other. Communication network 106 may itself be comprised of many interconnected computer systems and communication links. Communication links 108 may be hardwire links, optical links, satellite or other wireless communications links, wave propagation links, or any other mechanisms for communication of information. While in one embodiment, communication network 106 is the Internet, in other embodiments, communication network 106 may be any suitable communication network including a local area network (LAN), a wide area network (WAN), a wireless network, a intranet, private networks, public networks, switched networks, and the like. Various communication protocols may be used to facilitate communication between the various systems shown in FIG. 1. These communication protocols may include TCP/IP, HTTP protocols, extensible markup language (XML), wireless application protocol (WAP), IETF, vendor-specific protocols, customized protocols, and others.

In general, unless stated otherwise, the term “user system” may refer to any computer or data-processing system which may be used by a user to access information. For example, the user system may be a cell phone, a personal data assistant (PDA), a laptop, etc. In general, unless stated otherwise, the term “user” may refer to one or more human beings interacting with an user system 102, one or more processes executing on user system 102, systems or devices coupled to a user system 102, and other like entities which may access information via user system 102. In a web environment, user system 102 may be a computing device which a user may use to access information in the form of web pages provided by one or more content providers. For the computer network depicted in FIG. 1, the content providers may include content provider systems 104, vendor systems 112, SSPS 110, other user systems, or other devices/computer systems coupled to communication network 106.

In a web environment, users may generally access web pages using a “browser program” executing on user system 102. In order to access a web page, the user typically provides URL information to the browser, either directly or indirectly, and the browser responds by retrieving the web page corresponding to the URL information, and displaying it to the user on user system 102. While the present invention has been described using a web environment, it should be apparent that this does not limit the scope of the present invention as recited in the claims. The present invention can be used in various other environments.

A user may also use user system 102 to interact with other computer systems coupled to communication network 106. For example, a user may use user system 102 to participate in online shopping transactions including shopping for items related to projects. In accordance with the present invention, a user may use user system 102 to configure a purchase request identifying one or more projects and request purchase of items related to the one or more projects. In response to the purchase request, user systems 102 may receive information from SSPS 110 identifying purchasable units (also referred to as “purchasable items”) corresponding to the items described in the user-identified project(s). User system 102 may then output information related to the purchasable units to the user and allow the user to purchase the purchasable units.

A user may also use user system 102 to configure preferences (referred to as “user preferences”) related to user's web browsing and other online activities. For example, a user may configure preferences identifying a user's likes/dislikes and other shopping preferences. Examples of user preferences are discussed in U.S. patent application Ser. No. 09/502,863 (Attorney Docket No. 20004-000800US), entitled “SYSTEM AND METHOD FOR FACILITATING ONLINE SHOPPING ACTIVITIES” filed Feb. 11, 2000, the entire disclosure of which is herein incorporated by reference for all purposes. According to an embodiment of the present invention, the user's preferences may be stored by SSPS 110 and may be used by SSPS 110 to determine information to be provided to the user in response to a purchase request received from the user.

It should be apparent that user system 102 may also be used to perform a variety of other functions and tasks. Further details related to processing performed by user system 102 are described below. In a client-server environment, user systems 102 may operate as clients requesting information from server systems coupled to communication network 106 which perform processing in response to the client requests and provide the requested information to the client or user systems. It should however be apparent that a particular user system 102 may act both as a client or a server depending on whether the user system 102 is requesting or providing information. Various types of devices and systems may function as user system 102. These may include desktop computers, portable computers, personal digital assistants (PDAs), kiosks, touch screen displays, wireless communication devices, and other types of data processing devices.

In general, unless stated otherwise, the term “content provider system” may refer to any computer system which provides information which may be accessed via one or more user systems. In a web environment, a content provider system may provide content information which may be published/formatted in the form of web pages stored by content provider system 104. In general, the term “content information” may refer to any type of information or data. For example, content information may include text, images or graphics information, multimedia information, audio information, video information, and other types of information and combinations thereof. Accordingly, in a web environment, the term “content information” may include information displayed or published by the web pages. Vendor systems 112, SSPS 110, and user systems 102 may also function as content provider systems.

In accordance with the present invention, content information provided by content provider systems 104 may contain information describing one or more projects. For example, in a web environment, a web page provided by a content provider system may display project information such as a recipe for preparing a food item or a manual for repairing a leaking faucet, etc. The project information may typically describe several items required for completing the project and directions for completing the project. For example, information related to a food recipe project may include information describing ingredients required for preparing the food item, tools and utensils used in the preparation, and directions for the preparation.

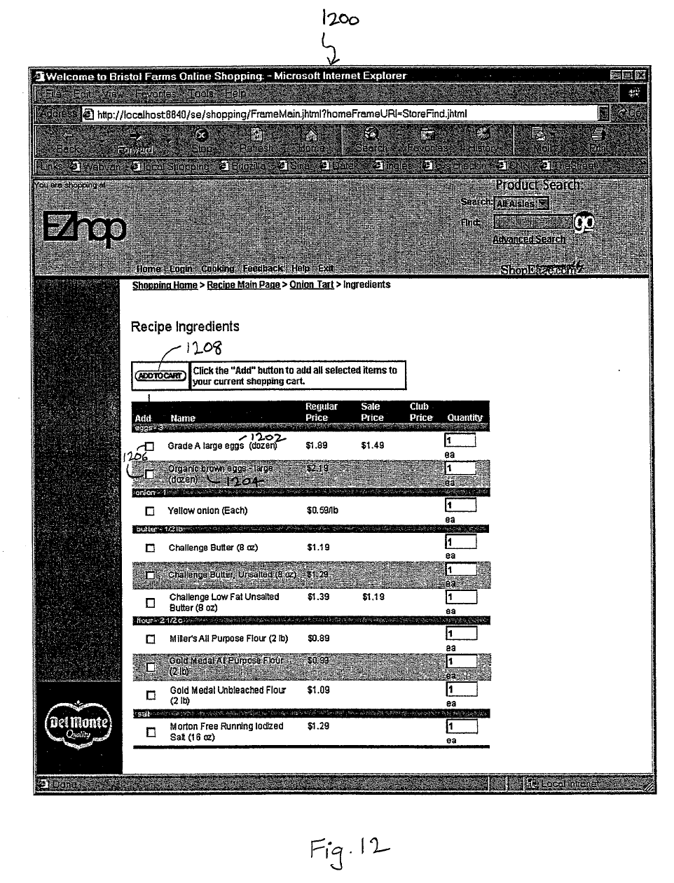

According to an embodiment of the present invention, web pages displaying information related to projects may also provide features which allow a user to shop for items related to the project (see web page 1100 depicted in FIG. 11 and discussed below). In response to a purchase request requesting purchase of items for a project, information related to user-selected project may be communicated from content provider system 104 to SSPS 110 for further processing. For the recipe example, the information communicated to SSPS 110 may include content information displayed by the web page related to the ingredients required for the food dish, tools required for preparing the food dish, and the directions for preparing the food dish. In alternative embodiments, a recipe identifier uniquely identifying the particular recipe may be communicated to SSPS 110. Additional details related to processing performed by content provider system 104 are discussed below.

In general, unless stated otherwise, the term “shopping services provider system” or “SSPS” may refer to any computer system which processes project-related purchase requests in accordance with the teachings of the present invention. According to an embodiment of the present invention, SSPS 110 may be configured to receive purchase requests comprising information related to one or more projects, to process the project(s) related information to identify items described in the project(s), to determine information related to purchasable units corresponding to the items described in the project(s), and to communicate information related to the purchasable units to the source (e.g. a requesting user system) of the purchase request. Further details related to the processing performed by SSPS 110 are discussed below.

In general, unless stated otherwise, the term “vendor system” may refer to any computer system which may be used by vendors to provide information related to purchasable units (e.g. via online product catalogs), or to provide other information in accordance with the present invention. In general, unless stated otherwise, use of the term “vendor” is intended to include sellers, retailers, manufacturers, distributors, merchants, e-commerce participants, and others which offer purchasable units for purchase by the user or provide information related to purchasable units. Further details related to processing which may be performed by vendor system 112 are discussed below.

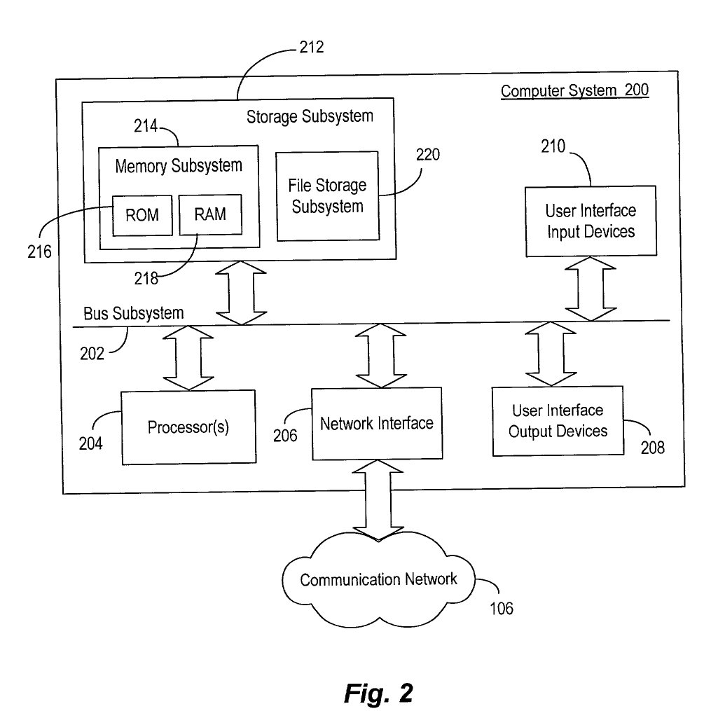

FIG. 2 is a simplified block diagram of an exemplary computer system 200 according to an embodiment of the present invention. Computer system 200 may function as user system 102, as content provider system 104, as vendor system 112, as SSPS 110, or other like system. Computer system 200 may include at least one processor 204, which communicates with a number of peripheral devices via bus subsystem 202. These peripheral devices may include a storage subsystem 212, comprising a memory subsystem 214 and a file storage subsystem 220, user interface input devices 210, user interface output devices 208, and a network interface subsystem 206. The input and output devices allow user interaction with computer system 200. As indicated above, a user may be a human user, a device, a process, another computer, and the like. Network interface subsystem 206 provides an interface to outside networks, including an interface to communication network 106, and may be coupled via communication network 106 to corresponding interface devices in other computer systems.

User interface input devices 210 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and ways to input information into computer system 200 or onto communication network 106.

User interface output devices 208 may include a display subsystem, a printer, a fax machine, or non-visual displays such as audio output devices. The display subsystem may be a cathode ray tube (CRT), a flat-panel device such as a liquid crystal display (LCD), or a projection device. The display subsystem may also provide non-visual display such as via audio output devices. In general, use of the term “output device” is intended to include all possible types of devices and ways to output information from computer system 200.

Storage subsystem 212 may be configured to store the basic programming and data constructs that provide the functionality of the computer system. For example, according to an embodiment of the present invention, software modules implementing the functionality of SSPS 110 may be stored in storage subsystem 212 of SSPS 110. These software modules may be executed by processor(s) 204 of SSPS 110. In a distributed environment, the software modules may be stored on a plurality of computer systems and executed by processors of the plurality of computer systems. Storage subsystem 212 may also provide a repository for storing various databases which may store information according to the teachings of the present invention. Storage subsystem 212 may comprise memory subsystem 214 and file storage subsystem 220.

Memory subsystem 214 may include a number of memories including a main random access memory (RAM) 218 for storage of instructions and data during program execution and a read only memory (ROM) 216 in which fixed instructions are stored. File storage subsystem 220 provides persistent (non-volatile) storage for program and data files, and may include a hard disk drive, a floppy disk drive along with associated removable media, a Compact Digital Read Only Memory (CD-ROM) drive, an optical drive, removable media cartridges, and other like storage media. One or more of the drives may be located at remote locations on other connected computers at another site coupled to communication network 106. Information stored according to the teachings of the present invention may also be stored by file storage subsystem 220.

Bus subsystem 202 provides a mechanism for letting the various components and subsystems of computer system 200 communicate with each other as intended. The various subsystems and components of computer system 200 need not be at the same physical location but may be distributed at various locations within distributed network 100. Although bus subsystem 202 is shown schematically as a single bus, alternative embodiments of the bus subsystem may utilize multiple busses.

Computer system 200 itself can be of varying types including a personal computer, a portable computer, a workstation, a computer terminal, a network computer, a mainframe, a kiosk, a PDA, a communication device such as a cell phone, or any other data processing system. Due to the ever-changing nature of computers and networks, the description of computer system 200 depicted in FIG. 2 is intended only as a specific example for purposes of illustrating the preferred embodiment of the computer system. Many other configurations of a computer system are possible having more or fewer components than the computer system depicted in FIG. 2.

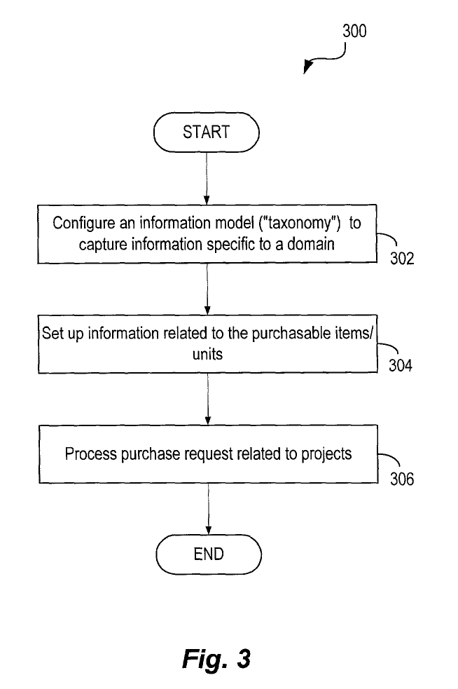

FIG. 3 is a simplified high-level flowchart 300 depicting processing performed according to an embodiment of the present invention. As indicated above, the present invention determines purchasable units information for items related to a user-selected project The projects may be from various different domains, e.g. related to food recipes, related to construction, related to hardware projects, etc.

According to an embodiment of the present invention, in order to facilitate the mapping of items included in a project to purchasable units, an information model or “taxonomy” is set up which captures information specific to the domain of the project (step 302). The domain-specific information captured by the taxonomy may include information about items which may be included in projects related to the domain, domain-specific relationships between the items (e.g. aggregate-component relationships between the items, generalization-specialization relationships between the items, etc.), and other information. Accordingly, the information model or “taxonomy” captures or stores information which is domain specific or domain implicit. For example, in order to process projects related to food recipes, a taxonomy is configured which captures and stores information related to food items and food recipes. The food-recipe specific taxonomy may store information related to food items and relationships between the food items. For example, items such as sugar, onions, salt, oil, egg yolk, eggs, lemons, lemon zest, lemon juice, etc. may be defined as items which may be included in food recipes. As indicated above, the taxonomy may also store information about relationships between the elements of the domain. For example, the food recipe taxonomy may store information indicating that an egg yolk is part of an egg, that food items lemon juice, lemon zest, and lemon wedges are parts of a lemon, that a chicken egg is a special type of egg, etc. A taxonomy is typically designed and populated by domain experts. According to an embodiment of the present invention, information related to a taxonomy may be stored by SSPS 110.

In accordance with the present invention, the taxonomy provides information which allows SSPS 110 to map items described in projects to purchasable units. According to an embodiment of the present invention, SSPS 110 may accomplish the mapping by first mapping the item descriptions in the projects to items specified by the taxonomy and them mapping the items specified by the taxonomy to purchasable units. Each item specified in the taxonomy may be uniquely identified by an item identifier (hereinafter referred to as an “item_id”). The taxonomy thus facilitates mapping of project item descriptions to item_ids which may then be mapped to purchasable units information.

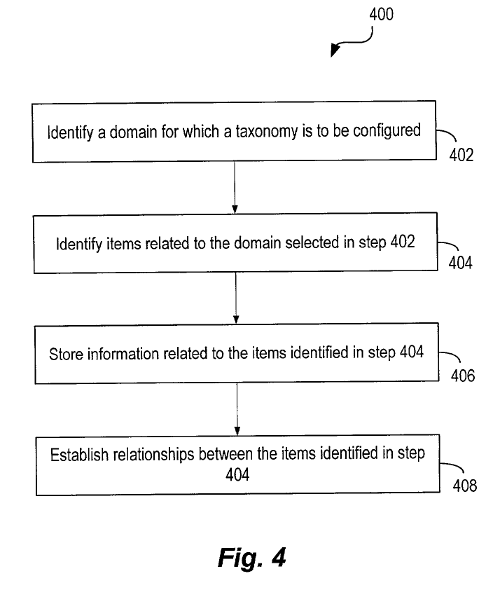

FIG. 4 is a high level simplified flowchart 400 depicting steps for configuring a taxonomy according to an embodiment of the present invention. As depicted in FIG. 4, the process is initiated by identifying a domain for which the taxonomy is to be configured (step 402). As indicated above, taxonomies may be configured for various domains e.g. food recipes/items domain, hardware domain, computer domain, etc. A list of items may then be determined for the domain selected in step 402 (step 404). The list of items generally comprises items which may occur in projects related to the domain. For example, for the food recipe/items domain, the list of items may include food items such as butter, sugar, beef, eggs, duck eggs, quail eggs, white chicken eggs, brown chicken eggs, etc.

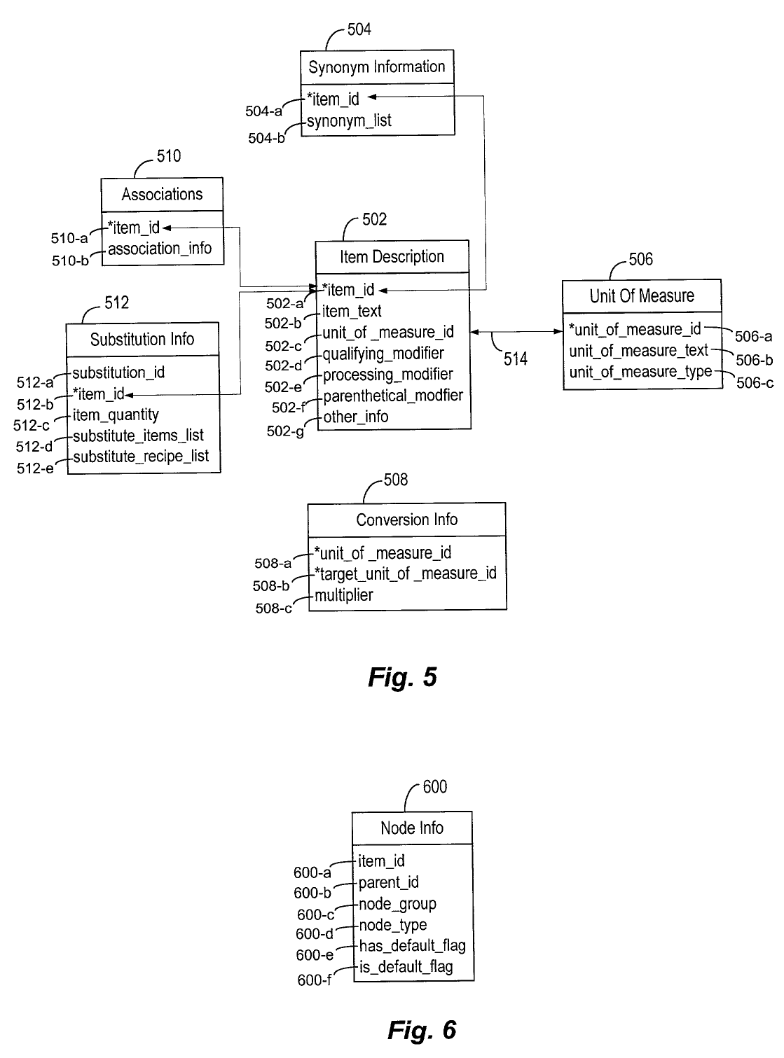

Information is then configured and stored for the items in the list of items identified in step 404 (step 406). The information stored for an item may describe various characteristics and attributes of the item. According to an embodiment of the present invention, various information organization techniques may be used to store information for the items. According to an embodiment of the present invention, the information may be stored in the form of tables of a database. As depicted in FIG. 5, these database tables may include a table “Item Description” 502, a table “Synonym Information” 504, a table “Unit Of Measure” 506, a table “Conversion Information” 508, a table “Associations” 510, and a table “Substitution Information” 512.

Each table may consist of a number of records, and each record in turn may comprise a number of fields which contain/store data. For example, table “Synonym Information” 504 contains records with fields “item_id” 504-a, and “synonym_list” 504-b. Each record may comprise an index (or primary key) which is a field which is unique to the table. In FIG. 5, the primary key fields have been marked with an asterix (“*”). Directed edges in FIG. 5 describe relations between the tables. For example, directed edge 514 from field “unit_of_measure_id” 502-c in table “Item Description” 502 to field “unit_of_measure_id” 506-a in table “Unit Of Measure” 506 indicates that for a record in table “Item Description” 502 there is a record in table “Unit Of Measure” 506 with the same “unit_of_measure_id”. In this manner, a record from one table may be related to a record from another table. This mechanism is well known from relational databases and allows for simple and efficient navigation through records and information stored in a database. The tables depicted in FIG. 5 have been designed specifically for a food recipe/items domain. It should be apparent that various other types of tables, data structures, and other techniques may be used to store information for items related to other domains.

According to an embodiment of the present invention, table “Item Description” 502 may be configured to store information for items in the list of items configured in step 404. Each record in table “Item Description” may store information for a particular item. Each record of table “Item Description” 502 may comprise the following fields: (a) an “item_id” field 502-a which stores a unique identifier identifying the item corresponding to the record; (b) an “item_text” field 502-b which stores a text string used for describing or displaying the item (e.g. a string “butter” may be used to describe item butter); (c) a “unit_of_measure_id” field 502-c which identifies a base unit of measure which may be associated with the item. Further information related to the unit of measure identified by the value of this field can be obtained from table “Unit of Measure” 506 (described below); (d) a “qualifying_modifier” field 502-d which stores information about qualitative or subjective information used to describe or characterize the item (e.g. “small”, “ripe”, “good quality”); (e) a “processing_modifier” field 502-e which stores information related to processing to which the item may have been subjected (e.g. “ground”, “skinned”, “butterflied”); (f) a “parenthetical_modifier” field 502-f which stores general information or directions which may be associated with the item (e.g. “rinsed thoroughly”); and (g) an “other_info” field 502-g which may be used to store other information related to the item. A plurality of records may be stored by table “Item Information” 502.

According to an embodiment of the present invention, table “Unit Of Measure” 504 may be configured to store information related to the various units of measure associated with the items specified for a domain (e.g. for item “sugar”, the unit of measure may be “pounds (lb.)”). Each record in table “Item Description” may store information for a particular unit of measure and may comprise the following fields: (a) a “unit_of_measure_id” field 504-a which uniquely identifies each unit of measure (e.g. if “pounds” is the unit of measure, the “unit_of_measure_id” field 504-a may also be set to “pounds” or some other unique value); (b) a “unit_of_measure_text” field 504-b which stores a text string used for describing or displaying the unit of measure (e.g. a string “pounds (lb.)”); and (c) a “unit_of_measure_type” field 504-c which may store information identifying the type of attribute of an item to which the unit of measure identified by “unit_of_measure_id” field 504-a applies. The types of units of measure may be domain specific. For example, for the cooking recipe domain, the types may be related to the length of an item, area of an item, volume of an item, weight of an item (e.g. pounds), packaging associated with an item (e.g. 19-oz. can, 8-oz. packet, etc.), and other types related to specific items (e.g. a clove of garlic, a head of garlic, a wedge of lemon, a whole lemon, a sprig, a pinch, a stick, etc.).

The present invention may also store information which facilitates conversions between the various units of measure. According to an embodiment of the present invention, the information for facilitating conversions may be stored in table “Conversion Information” 508. Each record of table “Conversion Information” 508 may comprise the following fields: (a) a “unit_of_measure_id” field 508-a identifying a unit of measure to be converted; (b) a “target_unit_of_measure_id” field 508-b identifying the target unit of measure or the unit of measure to which the unit of measure identified by “unit_of_measure_id” field 508-a is to be converted; and (c) a “multiplier” field 508-c storing a multiplier factor which when multiplied with the unit of measure identified by the “unit_of_measure_id” field 508-a converts it to the target unit of measure identified by the “target_unit_of_measure_id” field 508-b. For example, if “unit_of measure_id” field 508-a identifies a “pint” and “target_unit_of_measure_id” field 508-b identifies a “quart,” then “multiplier” field 508-c may store the value 0.5 which converts pints to quarts. This field may be null or empty based on the values of “unit_of_measure_id” field 508-a and “target_unit_of_measure_id” field 508-b.

For any given domain, an item may be described using different descriptors (“item descriptors”) such as synonyms. For example, powdered sugar, confectioner's sugar, superfine sugar, and powdered sugar may be used as synonyms referring to the same item. The present invention may store information to disambiguate the synonyms and to ensure that the synonyms map to the same item_id. This information may be stored in table “Synonym Information” 504. Each record of table “Synonym Information” 504 may comprise the following fields: (a) a “synonym_list” field 504-b which may store a list of synonyms. This list may include item descriptions which are to be mapped to the same item_id identified by “item_id” field 504-a. For example, a particular synonym list may comprise the terms (e.g. “powdered sugar”, “confectioner's sugar”, “superfine sugar”) which map to a single item_id. In alternative embodiments of the present invention, “synonym_list” field 504-b may contain one or more synonym identifiers. Each synonym identifier may then map (in a separate table) to a list of one or more synonym descriptors; and (b) an “item_id” field 504-a identifying the item_id for the synonyms listed in “synonym_list” field 504-b.

According to an embodiment of the present invention, the present invention may also store information about substitute(s) for items defined in the taxonomy and which may be used to replace an item. The type of substitutes may vary depending upon the domain and may include other items, combination of items, directions, recipes, etc. For example, in the food recipe domain, a substitute for a particular food item may be another food item of the same or different quantity, a combination of food items, a recipe for preparing the particular item, and the like. In accordance with the present invention, information related to substitutes may be stored in table “Substitution Information” 512 depicted in FIG. 5. Each record of the table may store information about substitutes for a particular item. Each record of table “Substitute Information” 512 may comprise the following fields: (a) a “substitution_id” field 512-a which may store information uniquely identifying substitution information for a particular item; (b) an “item_id” field 512-b which identifies the item to be substituted; (c) an “item_quantity” field 512-c which may store information identifying the quantity of the item identified by “item_id” field 512-b to be substituted (this value is typically one); (d) a “substitute_items_list” field 512-d listing one or more items (which may be identified by item_ids) which may be used as substitutes for the item identified by “item_id” field 512-b. For each substitute item identified by “substitute_items_list” field 512-d, the quantity of the substitute item which may be used in the substitution may also be specified. Further, according to an embodiment of the present invention, for each substitute item identified by “substitute_items_list” field 512-d, information identifying recipes where the substitute item maybe used (i.e. the substitution is allowed) instead of the item identified by “item id” field 512-b may also be provided; and (e) in the food recipe domain, a recipe may describe a preparation which may be used as a substitute for the item identified by “item_id” field 512-b. Information identifying the substitute recipe(s) may be stored in “substitute_recipe_list” field 512-e. For example, if “item_id” field 512-b identifies baking powder, and “item_quantity” field 512-c indicates a quantity of “1 teaspoon,” “substitute_recipe_list” field 512-e may store information indicating that ¼ teaspoon of baking soda mixed with ⅝ teaspoon of cream of tartar yields 1 teaspoon of baking powder. Various other substitute recipes may also be stored (scaling rules may replace quantities in the recipes). In alternative embodiments of the present invention, “substitute_recipe_list” field 512-e may contain one or more recipe identifiers. Each synonym identifier may then map (in a separate table) to recipes which may be used as substitutes for the item identified by “item_id” field 512-b. Further, according to an embodiment of the present invention, for each recipe identified by “substitute_items_list” field 512-d, information identifying recipes where the substitute recipe may be used (i.e. the substitution is allowed) instead of the item identified by “item_id” field 512-b may also be provided. The information stored in table “Substitution Information” 512 may be specific to a particular project, specific to a domain, etc.

Table “Associations” 510 may be used to store other information which may be associated with items defined in the taxonomy. Each record of table “Associations” 510 may store information for a particular item. The information may include marketing or promotional information associated with an item, information about complementary products for the item, domain-specific definitions for the item, advertising information for the item, branding information, and the like. Each record in table “Associations” 510 may comprise the following fields: (a) an “item_id” field 510-a identifying the item with which the information is to be associated; and (b) an “association_information” field 510-b identifying the information to be associated with the item identified by “item_id” field 510-a. In alternative embodiments of the present invention, “association_information” field 510-b may contain one or more identifiers. Each identifier may then map (in a separate table) to its corresponding association information.

Referring back to FIG. 4, after information for the items has been configured and stored according to step 406, relationships may then be defined between the various items identified in step 404 (step 408). According to an embodiment of the present invention, hierarchical relationships may be modeled using a multi-level tree structure comprising a plurality of nodes with multiple inheritance. Each node may represent a category or an item defined in the taxonomy for the domain. It should be apparent that various different types of relationships may be defined between the items based on the domain information. Further, while a tree structure is a specific technique of implementing the relationships, various other techniques may also be used to implement the relationships. Accordingly, the tree structure described in this application is not meant to limit the scope of the present invention as recited in the claims.

According to an embodiment of the present invention, the parent-child relationships between the nodes in the tree structure may be based upon generalization-specialization rules, such that an item represented by a child node is a specialization of the item represented by the parent node of the child node (or in other words, the item represented by a parent node is a generalization of an item identified by its child node). For example, a parent node may represent an “egg” item and the child nodes of the “egg” node may represent a “chicken egg”, a “quail egg”, and a “duck egg”, which are all specializations of a generic egg represented by the parent node. Various levels of generalization-specialization relationships may be defined in the taxonomy. Further, the tree structure may allow for multiple inheritance which allows a child node to inherit from one or more parent nodes. In this manner, specialized information may be provided for each category or item.

According to an embodiment of the present invention, a particular child node may be designated as the default value for the generalization represented by its parent node. For example, in a tree structure comprising a parent node representing an “egg” and having three child nodes representing “chicken egg”, “quail egg” and “duck egg” respectively, the “chicken egg” node may be designated as the default value for an egg. Accordingly, if a recipe specifies an egg without indicating any particular type of egg, based on the tree structure, SSPS 110 will determine a chicken egg as the default. In this manner, generic items defined in the taxonomy may be easily mapped to purchasable units/items.

Parent-child relationships between the nodes may also be based upon aggregation-component rules, such that an item represented by a child node is a component of the item identified by the parent node of the child node (in other words, the item represented by the parent node is an aggregation of component items represented by its child nodes). For example, a parent node may represent a “lemon” item and its child nodes may represent a “lemon wedge”, “lemon juice”, and “lemon zest” which are components of a lemon. Various levels of aggregate-component relationships may be defined in the taxonomy. Further, the tree structure may allow for multiple inheritance which allows a child node to inherit from one or more parent nodes.

According to an embodiment of the present invention, each node of the tree structure may comprise a “Node” data structure 600 depicted in FIG. 6. As depicted in FIG. 6, “Node” data structure 600 may comprise the following: (a) an “item_id” field 600-a which uniquely identifies the item or category represented by the node; (b) a “parent_id” field 600-b which may store information identifying the parent node (e.g. may store the item_id of the parent node). This value may be NULL if the node does not have any parents; (c) a “node_group” field 600-c which may store information indicating whether the node is a category or an item; (d) a “node_type” field 600-d which may store information indicating the type of category or item (further details provided below); (e) a “has_default_flag” field 600-e which indicates if a generalized item represented by the node has a default value. If the value of this field is set to 1, it indicates that the node has a default value which may be the value of a child node (where the item represented by the child node is a specialization of the item represented by the parent node). For example, this flag may be set to “1” in a node representing an “egg” if a “chicken egg”, represented by a child node, is the default value for an egg. This value is set to zero in the general case with no default value; (f) an “is_default_flag” field 600-f indicating if the item represented by the node is a default for some generalization (usually represented by a parent node).

As indicated above, each node in the tree structure may represent an item or a category. A node classified as a category is generally involved in a generalization-specialization relationship and represents a non-purchasable item/unit, e.g. “deli,” “seafood.” Categories may be used for purposes of organizing the hierarchy information stored by the tree structure. The “node_type” field 600-d for a root node of the tree is set to “top_category”. The “node_type” field 600-d for other nodes representing categories may be set to a particular category.

For a node representing an item, “node_type” field 600-d may be set to “generalization,” “aggregate,” “component”, or simply “item”. The node type is set to “generalization” if the item represented by the node is a generalized item which can be further specialized by its child nodes. For example, the node type of a node representing an egg may be set to “generalization” since an egg can be further specialized as a chicken egg, a duck egg, a quail egg, etc. Likewise, the node type of a node representing “oil” may be set to “generalization” since oil can be further specialized as corn oil, peanut oil, vegetable oil, etc.

“Node_type” field 600-d for a node may be set to “aggregate” if the item represented by the node is an aggregate of items represented by its child nodes. For example, the node type of a node representing a “lemon” may be set to “aggregate” as a lemon is an aggregation of lemon juice, lemon zest, lemon wedges, etc. Nodes which are children of a node of type “aggregate” and which represent items which are components of the aggregate may have their node type set to “component.” For example, the “node_type” field 600-d for nodes representing lemon zest, lemon juice, and lemon wedges is set to “component.”

In accordance with the present invention, “node_type” field 600-d for a particular node may be set to more than one value. For example, a particular node may be a component and also a generalization, or both an aggregation and a component, and the like. As indicated above, according to an embodiment of the present invention, nodes may represent items which are purchasable units.

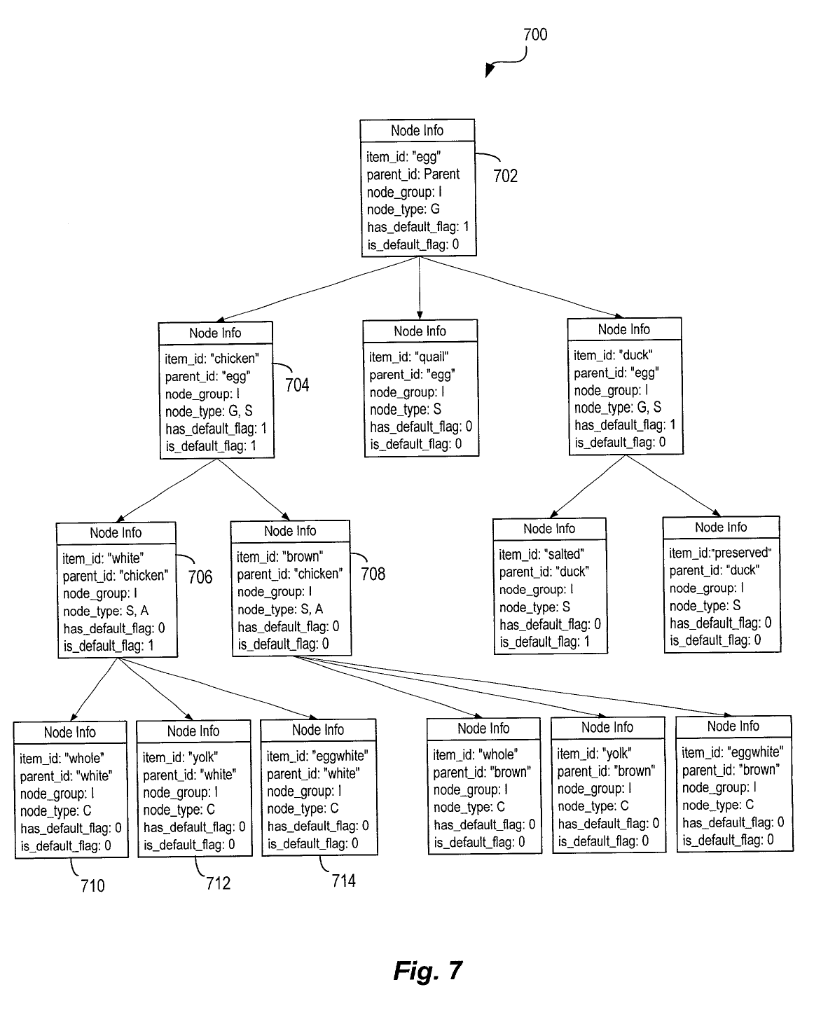

FIG. 7 depicts a sub-tree 700 of a taxonomy tree structure storing hierarchy relationship information for eggs according to an embodiment of the present invention. Values for the node_group have been indicated by “I” for item (although not shown in FIG. 7, as described above, node_group may also have a value of “category”). Values for the “node_type” field have been indicated by “G” (generalization), “S” (specialization), “A” (aggregate), and “C” (component). As shown in FIG. 7, node 702 representing an egg, is tagged as a “G” node type, and has its “has_default flag” set to 1 indicating that one of its child node is tagged as the default (in this case it is node 704 representing a chicken egg which has its “is_default_flag” set to 1 indicating that it is the default for its parent node generalization). Node 704 representing a chicken egg is tagged as having a “G” and a “S” node type. This indicates that node 704 is a specialization of its parent node, but it can further be specialized by its child nodes 706 and 708. Nodes 710, 712, and 714 representing a whole egg, egg yolk, and egg white, respectively, are components of aggregate node 706.

Referring back to FIG. 3, after an information model or taxonomy has been configured for a particular domain according to step 302, the items specified by the taxonomy are then mapped to purchasable items/units and their related information (step 304). According to an embodiment of the present invention, information related to purchasable units is associated with item_ids specified by the taxonomy. The information related to purchasable units may be obtained from product/item catalogs provided by vendors, from product information provided by vendors, or from other sources accessible to SSPS 110.

FIG. 8 depicts a mapping of item_ids to purchase units according to an embodiment of the present invention. As depicted in FIG. 8, a single item_id may map to one or more purchasable units. For example, “item_id#1” in FIG. 8 maps to “purchase_unit#1” “purchase_unit#2”, and “purchase_unit#4” (e.g. an item_id corresponding to “milk” may map to “a bottle of Brand X milk”, “a of Brand X skimmed milk”, “a bottle of Brand Y milk”, etc.). Further, two or more different item_ids may map to the same purchase unit(s). For example, as depicted in FIG. 8, “item_id#3” and “item_id#5” map to the same purchase unit “purchase_unit#5” (e.g. the item_ids corresponding to “lemon juice” and “lemon zest” may both map to a “lemon from grocery store XYZ”). In general, an item_id may map to one or more purchase units, and a purchase unit may map to one or more item_ids.

The mappings between item_ids and purchase units may be configured by providers of SSPS 110 or by vendors providing information related to the purchase units. For example, vendors may provide purchase units information and indicate the item_ids which should map to the different purchase units. Alternatively, providers of SSPS 110 may determine purchase units information from vendor product catalogs or information provided/published by the vendors and map the information to item_ids defined in the taxonomy.

Information stored by the taxonomy may also influence the mapping of item_ids to purchasable units. For example, the aggregate-component relationships encapsulated by the taxonomy may be used to determine the mapping. For example, for an item such as “egg yolk,” it may be determined from the taxonomy that it is a component of an “egg” (aggregate item) and accordingly the item_id associated with egg yolk may be mapped to purchase units corresponding to an item_id associated with an egg. The mapping may also be based upon default values associated with generalized items in the taxonomy. For example, for a generalized item such as “egg,” in absence of additional qualifying information, the item_id associated with an egg may be mapped to purchase units comprising chicken eggs if chicken eggs is specified as the default for the “egg” item generalization in the taxonomy. Other information stored by the taxonomy may also be used to determine the mapping between item_ids and information related to purchasable units.

Based on the mapping information, an item identified by a particular item_id can be translated to one or more purchasable unit(s) corresponding to the item. According to an embodiment of the present invention, the information mapping item_ids to purchase units (referred to as “item_ids_to_purchase units” mapping information) may be stored by SSPS 110 or alternatively may be accessed by SSPS 110 from a system coupled to SSPS 110.

According to an embodiment of the present invention, the item_ids discussed in this application are like the “tokens” discussed in U.S. patent application Ser. No. ______ (Attorney Docket No. 20004-000710US), entitled “A TOKENS-BASED SYSTEM FOR PROVIDING INFORMATION TO USERS” filed concurrently with this application, the entire disclosure of which is herein incorporated by reference for all purposes. Accordingly, in accordance with the present invention, various techniques discussed in U.S. patent application Ser. No. ______, (Attorney Docket No. 20004-000710US) may be used to determine item_ids corresponding to information contained in the purchase request, and to map item_ids to information related to purchasable units.

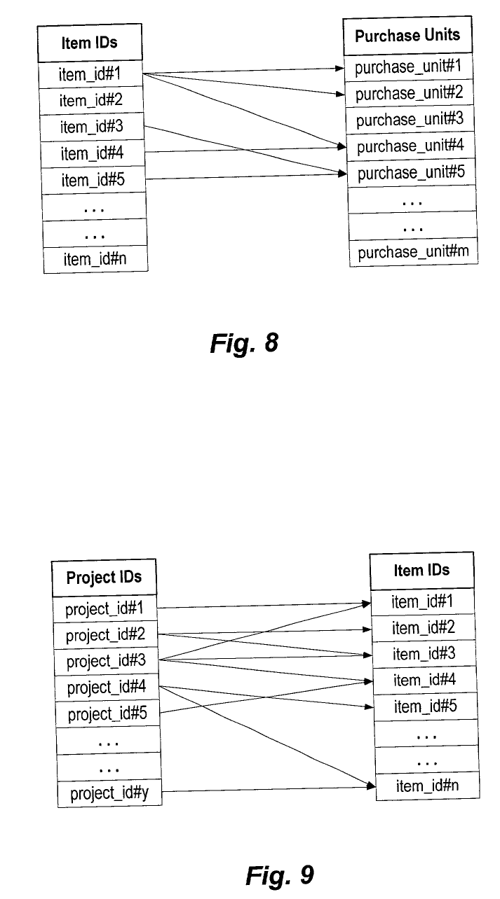

According to an embodiment of the present invention, the present invention may also store information mapping projects to item_ids. Each project may be uniquely identified by a “project_id”. Each project_id may map to one or more item_ids identifying items related to the project. Quantities of the item_ids for the project may also be stored. The project_id to item_id(s) mapping information may be stored by SSPS 110. FIG. 9 depicts a mapping of project_ids to item_ids according to an embodiment of the present invention. As indicated above, quantities of the item_ids for each project_id may also be stored (not shown in FIG. 9). As depicted in FIG. 9, a single project_may map to one or more item_ids which may in turn map to one or more purchasable units as depicted in FIG. 8.

Referring back to FIG. 3, after a taxonomy has been configured for a particular domain according to step 302 and associations/mappings have been configured according to step 304, the present invention may then receive and process purchase requests related to projects and determine purchasable units information for items specified in the projects (step 306).

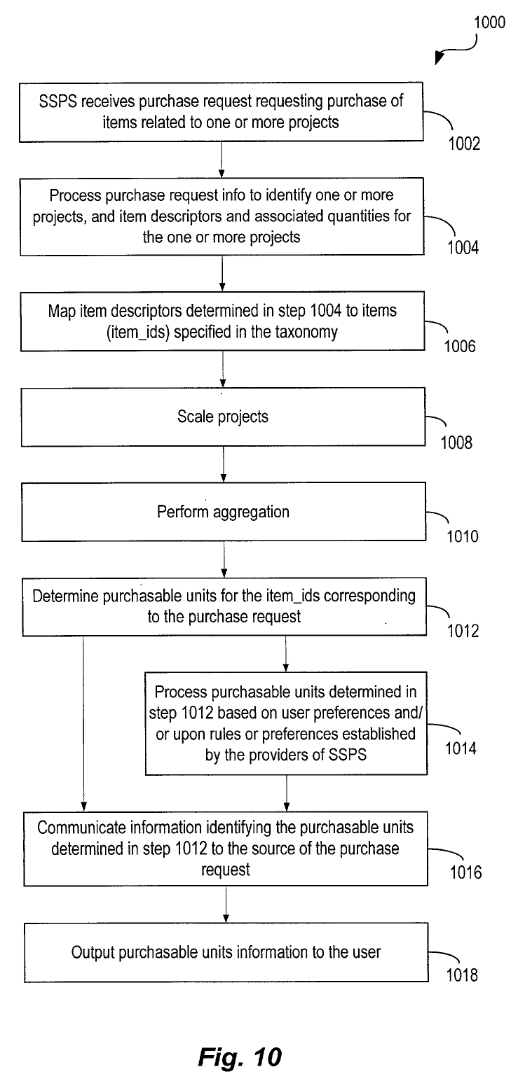

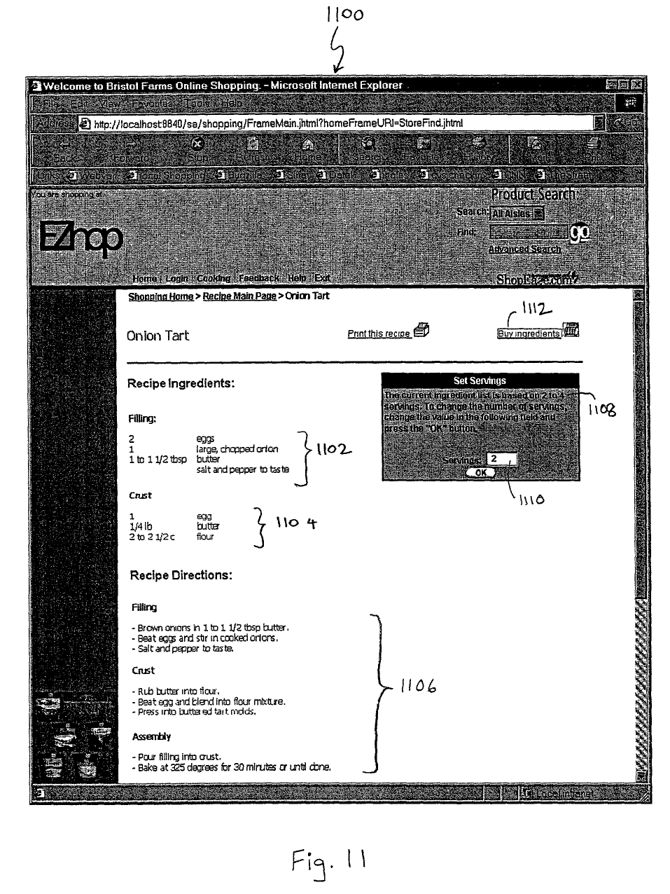

FIG. 10 is a simplified high-level flowchart 1000 showing processing performed by SSPS 110 as part of step 306 in FIG. 3 according to an embodiment of the present invention. As depicted in FIG. 10, the process may be initiated when SSPS 110 receives a purchase request requesting purchase of items related to one or more projects (step 1002). The purchase request may contain information identifying the one or more projects and information related to the items included in the projects. According to an embodiment of the present invention, the purchase request information may also include information indicating a scaling factor to be applied to one or more projects.

SSPS 110 may receive the purchase request from various different sources and interfaces. According to an embodiment of the present invention, the purchase request may be received from a content provider system 104 which provides web pages displaying information related to one or more projects identified by the purchase request. For example, a user using user system 102 may access a web page provided by a content provider system which contains information related to a project. An example of such a web page is depicted in FIG. 11. As depicted in FIG. 11, web page 1100 displays information describing a project, namely a recipe for making an “Onion Tart.” The recipe includes ingredients 1102 for making the tart filling, ingredients 1104 for making the tart crust, and directions 1106 for making the tart. Web page 1100 also displays the number of servings 1108 provided by the recipe, namely 2-4 servings.

The user may initiate a request to purchase items related to the “Onion Tart” recipe by indicating the number of servings desired (in field 1110, which may default to value 1108), and then selecting “Buy ingredients” option 1112. In response to selecting “Buy ingredients” option 1112, a purchase request may be generated and communicated from the content provider system providing web page 1100 to SSPS 110. The purchase request may comprise information related to the “Onion Tart” recipe including information related to ingredients 1102 and 1104 and directions 1106 associated with the recipe. The purchase request may also contain scaling information for the project, i.e. the number of servings which the user desires to make as indicated by the user in field 1110. According to an embodiment of the present invention, the purchase request information may comprise information (e.g. “project_id” for the recipe) uniquely identifying the “Onion Tart” recipe.

As indicated above, SSPS 110 may also receive purchase requests from various other sources and interfaces other than web pages. These interfaces/sources may include, for example, devices coupled to SSPS 110 via wired or wireless links, various hardware or software modules such as browser plug-ins, code modules, etc., information storage media such as computer disks, CD-ROMs, DVDs, etc., and the like. Examples of techniques for providing purchase request information to SSPS 110 are discussed in U.S. patent application Ser. No. ______ (Attorney Docket No. 20004-000710US), entitled “A TOKENS-BASED SYSTEM FOR PROVIDING INFORMATION TO USERS” filed concurrently with this application, the entire disclosure of which is herein incorporated by reference for all purposes. It should be apparent that various other techniques may also be used to provide purchase request information to SSPS 110 in accordance with the present invention.

Upon receiving the purchase request information, SSPS 110 may then process the information to identify the one or more projects and items (ingredients if the project is a food recipe) described in the project(s) and quantities associated with the item descriptions (step 1004). A unique identifier (“project_”) may be assigned to each project described in the purchase request (unless the project_id is already specified in the purchase request). SSPS 110 may use various techniques to extract item descriptions (or item descriptors) and associated quantity information from the purchase request information. According to an embodiment of the present invention, the project related information included in the purchase request information may be in the form of raw text. In this embodiment, SSPS 110 may parse the contents of the project information to extract keywords identifying items related to the projects. SSPS 110 may use information stored by the taxonomy for the project domain to perform the processing.

For example, for the “Onion Tart” recipe depicted in FIG. 11, item descriptors such as “eggs,” “large chopped onion,” “butter,” “salt and pepper,” and “flour” may be extracted from the project related information. For each item, the quantity and unit of measure (e.g. 1½ tbsp. butter) associated with the item descriptions may also be extracted. If a range of measurements is indicated (e.g. 1 to 1½ tbsp butter), according to an embodiment of the present invention, the higher measurement (i.e. 1½ tbsp) may be extracted.

SSPS 110 may use various techniques for extracting item descriptors from the projects related information included in purchase request. A first extraction technique may use a list of item descriptors stored by SSPS 110. According to the first extraction technique, SSPS 110 may parse the projects related information included in the purchase request to extract or item descriptors which match item descriptors in the list of item descriptors.

According to another technique, item descriptors may be extracted based upon tags/attributes associated with the item descriptors in the projects related information included in the purchase request. The tags may convey attribute special meaning to the keywords. For example, SSPS 110 may extract all words from the content information which have been bolded or underlined or italicized, etc. Non-textual item descriptors such as audio clips, video clips, etc. may also be tagged and extracted by SSPS 110.

As discussed above with reference to FIG. 9, SSPS 110 may store information mapping certain project_ids to item_ids. If a project identifier (a “project_”) is specified in the purchase request, SSPS 110 may determine if the particular project_id has already been mapped to item_ids. If the project_id has already been mapped to one or more item_ids, SSPS 110 may directly determine item_ids corresponding to the project and thus SSPS 110 need not parse the project related content to determine the items.

SSPS 110 may then, based on information stored by the taxonomy, map the item descriptors extracted from the project(s) information in step 1004 to items specified in the taxonomy(ies) for the projects (step 1006). According to an embodiment of the present invention, SSPS 110 may determine item_ids (defined in the taxonomy) for each item descriptor extracted from the purchase request information. According to an embodiment of the present invention, item_ids may be determined by comparing the item descriptors extracted from the project information in the purchase request with information stored in the taxonomy, e.g. information stored by table “Synonym Information” 504. For example, for a particular item descriptor extracted from the project information, SSPS 110 may determine a synonym_list 504-b stored by table “Synonym Information” 504 which contains a synonym which matches the item descriptor, and then determine the item_id 504-a corresponding to the synonym_list. The particular item descriptor is deemed to map to the item_id which identifies an item specified in the taxonomy. As a result of such processing, item descriptions such as powdered sugar, confectioner's sugar, superfine sugar, and powdered sugar may map to a single item_id in the taxonomy.

In this manner, item_ids are determined for the various item descriptors extracted from the project related information. Quantity information associated with the item descriptors is also associated with the item_ids. According to an embodiment of the present invention, the output of step 1006 may comprise tuples of (item descriptor, item_id corresponding to the item descriptor, quantity associated with the item descriptor). It should be apparent that the certain item descriptors may not have any quantity information associated with them.

As indicated above, if a project (identified by a “project_”) specified in the purchase request has already been mapped to item_ids, SSPS 110 may determine item_ids for the project by referring to the project_id to item_id mapping information.

For each project identified in the purchase request, SSPS 110 may then scale the quantities associated with each item descriptor (or each (item descriptor, item_id, quantity) tuple) for a project up or down based on scaling information (e.g. information entered in field 1110 of FIG. 11) requested for the project (step 1008). The scaling information identifies the scale of the project, which for a recipe may specify the number of servings for the recipe. For the “Onion Tart” recipe depicted in FIG. 11, scaling information corresponds to the value entered by the user in field 1110. The quantities associated with each (item descriptor, item_id, quantity) tuple for a project may be scaled up or down by a scaling multiplier based upon the scaling information associated with the project in the purchase request. For example, if a user indicated in field 1110 of FIG. 11 that the “Onion Tart” recipe be scaled for 4-8 servings (recipe as displayed is for 2-4 servings), a scaling multiplier of 2 may be used to double the quantity of each item in the recipe. According to a simple embodiment of the present invention, all items in a project may be scaled linearly. For example, each item in the “Onion Tart” recipe may be multiplied by a scaling multiplier “2” to determine the quantities of the ingredients.

However, all items of a project may not scale linearly in all circumstances. In order to facilitate non-linear scaling of project items, SSPS 110 may store “scaling rules” which may specify the manner in which scaling is to be performed for the various projects. According to an embodiment of the present invention, SSPS 110 may store a list of projects (e.g. food recipes) and rules governing how items included in the projects are to be scaled for different scaling requirements or conditions. The scaling rules may also impose constraints on the scaling. For example: the scaling multiplier may be restricted between a minimum and maximum value, fractional scaling may be restricted, and the like.

As described above, scaling may be performed in response to scaling requirements associated with a project and received via the purchase request. In accordance with the present invention, scaling may also be performed based upon other factors such as the geographical location where the project is to be performed, etc. For example, altitude adjustment usually changes quantities associated with liquids in a recipe. Information related to the various factors which may trigger scaling and the manner in which scaling is to be performed may be stored as part of the scaling rules. The scaling rules may also indicate the manner in which substitute items (i.e. items which may be used in lieu of the items described in the project) are to be scaled.

Referring back to FIG. 10, after performing scaling, SSPS 110 may then aggregate the scaled items of the one or more projects (step 1010). Aggregation generally involves determining (item descriptor, item_id, quantity) tuples which have the same item_id, summing the quantities indicated by the tuples, and associating the sum with the item_id. In effect, as a result of aggregation, SSPS 110 determines the total quantity of an item required for a project or for the purchase request (i.e. quantities associated with item descriptors which map to the same item_id are merged or aggregated). Aggregation may be performed within a particular project (intra-project) and/or between two or more projects (inter-project aggregation) specified in the purchase request. Inter and intra-project aggregation may be user-configurable options.

Intra-project aggregation may be performed when a project includes smaller projects or sub-projects each having its own list of items. Intra-project aggregation involves performing aggregation on tuples associated with a particular project. Intra-project aggregation thus determines the unique item_ids for a project and quantities associated with item_ids for preparing/performing the project. Accordingly, as part of intra-project aggregation, for each unique item_id for a project, SSPS 110 may determine the total quantity of the item, as represented by item_id, required for the project. For example, the “Onion Tart” recipe depicted in FIG. 11 includes two sub-projects, namely a sub-project for preparing the filling and a sub-project for preparing the crust. Further, the recipe indicates that 2 eggs are required for preparing the filling and 1 egg is required for preparing the crust. As a result of intra-project aggregation, SSPS 110 may determine that a total of 3 eggs are required (aggregation of 2 eggs for preparing the filling and 1 egg for preparing the crust) for the “Onion Tart” recipe. If the quantities to be aggregated are specified using different units of measure (e.g. 1½ tbsp. of butter for preparing the filling, and ¼ lb. of butter for preparing the crust), then SSPS 110 may use information stored in table “Conversion Information” 508 to determine a common unit of measure for the quantities and then perform aggregation using the common unit of measure. Intra-project aggregation is generally performed prior to inter-project aggregation.

Inter-project aggregation may be performed by SSPS 110 when the purchase request identifies more than one project. Inter-project aggregation involves performing aggregation on tuples associated with the purchase request (across projects in a purchase request). Inter-project aggregation thus determines the unique item_ids for a purchase request and quantities associated with item_ids for preparing/performing the various projects specified in the purchase request. As part of inter-project aggregation processing, SSPS 110 may determine the items corresponding to the item_ids for the various projects and perform a summation of the quantities for like items. According to an embodiment of the present invention, inter-project aggregation may be a user-configurable option allowing the user to control whether or not inter-project aggregation is to be performed. For example, inter-project aggregation processing may be disabled by users who prefer to purchase items on a project-by-project basis.

SSPS 110 may then determine purchasable units corresponding to the item_ids determined for the purchase request (step 1012). According to an embodiment of the present invention, the “item_id-to-purchase unit” mapping information (described above and depicted in FIG. 8) accessible to SSPS 110 may be used to determine the purchase units corresponding to the item_ids determined in step 1010. SSPS 110 may prepare a list of purchase units corresponding to each project identified in the purchase request (if the purchase request specifies more than one project and the inter-projects aggregation option has been disabled) or a single purchase items list may be prepared for the purchase request (if the purchase request specifies only one project or if the inter-projects aggregation option has been enabled).

According to an embodiment of the present invention, SSPS 110 may be configured to determine the smallest quantity of each purchasable unit required for the project(s) in the purchase request. This feature to determine the smallest quantity may be user configurable. If this option has been enabled by the user, as part of step 1012, SSPS 110 may perform processing to determine the smallest quantity of each purchasable unit required for the project(s) in the purchase request. If the inter-projects aggregation option has also been enabled, SSPS 110 may determine the smallest quantities of the purchasable units which satisfy the quantities of items for all projects specified by the purchase request. If the inter-projects aggregation option has been disabled, the calculation of the smallest quantities of the purchasable units may be performed on a per project basis for each project specified in the purchase request. For example, if a particular recipe requires ¼ lb. of butter, SSPS 110 may determine that an item_id corresponding to butter maps to purchasable units including butter packages provided by Land O'Lakes butter available in packaging sizes of 1 lb., 2 lbs., and 4 lbs. SSPS 110 may determine that the smallest package of butter which satisfies the user request is the 1 lb. packaging size. The 2 lb. and 4 lb. Land O'Lakes butter units may accordingly be excluded from the list of purchasable units for the project. According to an embodiment of the present invention, information stored in tables “Unit Of Measure” 506 and “Conversion Information” 508 of the taxonomy may be used to determine the smallest quantities of the purchasable units.

In certain situations, a particular item_id may not map to any purchasable units or alternatively purchase units to which an item_id maps may not be available (e.g. out of stock, discontinued, etc.). In these type of situations, as part of the processing performed in step 1012, SSPS 110 may determine one or more substitutes for the particular item_ids. According to an embodiment of the present invention, SSPS 110 may use information stored by table “Substitution Information” 512 to determine substitutes for the items associated with the item_ids. The substitutes may be domain specific and may include other items defined in the taxonomy, other recipes, directions, etc. Information related to the substitutes may be communicated to the source of the purchase request along with the list of purchasable units according to step 1016. Options and services may also be provided allowing the user to purchase the substitutes.

According to an embodiment of the present invention, SSPS 110 may then communicate the list of purchasable units and other information (e.g. information about substitutes) to the source of the purchase request (step 1016). For example, information related to items in the list of purchasable items may be sent to a user system 102 which was the source of the purchase request which triggered determination of the list of purchasable items. Information associated with the list of purchasable units may then be presented to the user (step 1018).

According to alternative embodiments of the present invention, SSPS 110 may further process the information related to the list of purchasable units determined in step 1012 based on user preferences and/or upon rules or preferences established by the providers of SSPS 110 (step 1014). As discussed in U.S. patent application Ser. No. 09/502,863 (Attorney Docket No. 20004-000800US), entitled “SYSTEM AND METHOD FOR FACILITATING ONLINE SHOPPING ACTIVITIES” filed Feb. 11, 2000, several user preferences may be specified or configured related to items purchased by the user. As part of the processing performed in step 1014, SSPS 110 may filter the list of purchasable items based upon user preferences such that only those purchasable units which satisfy the user preferences are included in the list of purchasable units which is communicated to the user. For example, the list of purchasable units determined in step 1012 may include purchasable units of Brand X milk and Brand Y milk. However, if the user preferences indicate that the user who initiated the purchase request prefers Brand X only, the Brand Y milk unit may be removed from the list of purchasable units communicated to the user. The filtered list of purchasable items may then be communicated to the source of the purchase request according to step 1016. Further details related to generation of presentation lists and processing which may be performed by the present invention in response to user preferences are discussed in U.S. patent application Ser. No. 09/502,863 (Attorney Docket No. 20004-000800US), entitled “SYSTEM AND METHOD FOR FACILITATING ONLINE SHOPPING ACTIVITIES” filed Feb. 11, 2000, the entire disclosure of which is herein incorporated by reference for all purposes.

During step 1016, SSPS 110 may also process the list of purchasable items determined in step 1012 based upon rules or preferences configured by providers of SSPS 110. These rules or preferences may include e-marketing rules, priority rules, branding rules, and the like. For example, these rules may indicate that certain vendors be preferred over other vendors, certain brands be preferred over other brands, certain items be preferred over other items, and the like. For example, a particular rule may specify that for a particular item_id specified in the taxonomy, only purchasable units from vendor “Vₙ” are to be forwarded to the user, even though the list of purchasable units determined in step 1012 for the particular item_id may contain purchasable units from other vendors. In applying this rule, SSPS 110 may filter out all purchasable units from the other vendors from the list of purchasable units before communicating the list to the source of the purchase request according to step 1016.

In this manner, providers of SSPS 110 may allow a vendor to have exclusive rights or special rights to one or more item_ids. Rules may also be specified which allow providers of SSPS 110 to “rent” out one or more item ids to one or more vendors for a specific period of time, such that during the specific period of time, purchasable units from only those vendors who have “rented” the item_ids are communicated in response to a purchase request. Rules may also be specified related to the frequency of use of the item_ids.

Rules may also be defined to specify the manner in which the information is to be presented to the user (e.g. presentation list rules). For example, items from a “preferred” vendor may be presented to user in a special manner with the appropriate web page geometry. SSPS 110 may accordingly format the purchasable units information to be communicated to user system 102 to comply with the presentation rules. Further details related to presentation lists are discussed in U.S. patent application Ser. No. 09/502,863 (Attorney Docket No. 20004-000800US), entitled “SYSTEM AND METHOD FOR FACILITATING ONLINE SHOPPING ACTIVITIES” filed Feb. 11, 2000, the entire disclosure of which is herein incorporated by reference for all purposes.

As discussed above, user system 102 may then output the purchasable units information to the user (step 1018). Various different techniques may be used to present the list of purchasable units received from SSPS 110 to the user. According to an embodiment of the present invention, user system 102 may display user interfaces which displays information related to the list of purchasable units received from SSPS 110 to the user. Other output devices coupled to user system 102 may also be used to present the information to the user. U.S. patent application Ser. No. 09/502,863 (Attorney Docket No. 20004-000800US), entitled “SYSTEM AND METHOD FOR FACILITATING ONLINE SHOPPING ACTIVITIES” filed Feb. 11, 2000, discusses examples of user interfaces which maybe used to provide information to the user.

According to an embodiment of the present invention, user interface 1200 depicted in FIG. 12 may be used for displaying information received from SSPS 110 to the user. User interface 1200 depicted in FIG. 12 is merely illustrative of a specific embodiment of the present invention and does not limit the scope of the invention as recited in the claims. One of ordinary skill in the art would recognize other variations, modifications, and alternatives.

As shown in FIG. 12, user interface 1200 displays information about purchasable units corresponding to the “Onion Tart” recipe depicted in FIG. 11. Purchasable units are displayed for each unique item (namely, eggs, onion, butter, flour, and salt) described in the “Onion Tart” recipe. For example, two purchasable items “Grade A large eggs (1 dozen)” 1202 and “Organic brown eggs-large (1 dozen)” 1204 are displayed for the item description “eggs.” Likewise, information identifying purchasable units for the other items described in the recipe are displayed. For each purchasable unit, the minimum purchasable quantity of the unit which satisfies the quantity required by the recipe, the price associated with the purchasable unit, and a sale price if applicable, are also displayed. Information related to substitutes may also be displayed via a user interface 1200 (not shown).

Check boxes 1206 allow a user to select a purchasable unit for purchase. A user may select one or more purchasable units for purchase by checking check boxes 1206 associated with the units and by selecting “Add To Cart” button 1208. Selecting “Add To Cart” button 1208 causes the “checked” purchasable items to be added to the user's shopping cart. The user may then consummate the purchase transaction using techniques well known to those skilled in the art.

According to an embodiment of the present invention, the selected purchasable items may be aggregated with other purchasable items already existing in the shopping cart. According to alternative embodiments, the purchasable items in the shopping cart may be organized on a per project basis. In this embodiment, the cost of materials for a project may be calculated by summing the costs of the purchasable items included in the project. Promotions or discounts may also be offered to the user on a per project basis.

It should also be apparent that other output interfaces, in addition to web pages, may also be used to provide the information to the user. For example, output devices coupled to user system 102 may also be used to present the information to the user. The user may then proceed with the purchase transaction based upon the information presented to the user.

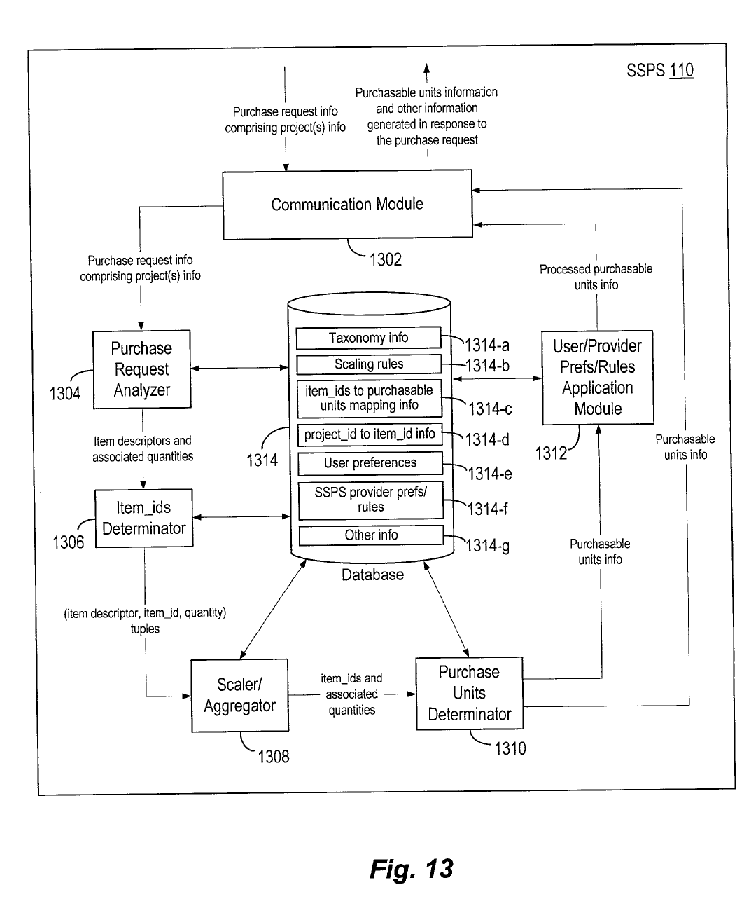

FIG. 13 is a simplified block diagram showing the various modules/engines of SSPS 110 which may be used to process a purchase request related to project(s) according to an embodiment of the present invention. The modules depicted in FIG. 13 may be implemented in software or hardware or combinations thereof. As shown in FIG. 13, the modules may include a communication module 1302, a purchase request analyzer module 1304, an item_ids determinator module 1306, a scaler/aggregator module 1308, a purchase units determinator module 1310, a user/provider preferences/rules application module 1314, and a database 1314.

Communication module 1302 may be configured to facilitate communication of information and data to and from SSPS 110. In the inbound direction, communication module 1302 may receive a purchase request requesting purchase of items related to one or more projects. Communication module 1302 may forward the purchase request information to purchase request analyzer module 1304 for further processing. In the outbound direction, communication module 1302 may receive information related to purchasable units determined by SSPS 110 in response to the purchase request. Communication module 1302 may then forward the purchasable units information to the source of the purchase request. According to an embodiment of the present invention, communication module 1302 performs processing performed in steps 1002 and 1016 in FIG. 10.

Purchase request analyzer module 1304 may be configured to analyze the purchase request information to identify information related to one or more projects, and to extract item descriptors and their associated quantities from the projects information. Purchase request analyzer module 1304 may use taxonomy information 1314-a to perform the processing. According to an embodiment of the present invention, purchase request analyzer module 1304 performs processing performed in step 1004 in FIG. 10. The item descriptors and associated quantities extracted by purchase request analyzer module 1304 may then be forwarded to item_ids module 1306 for further processing.

Item_ids determinator module 1306 may be configured to map item descriptors extracted from the purchase request information to item_ids specified in the taxonomy. Item_ids determinator module 1306 may use taxonomy information 1314-a to determine the item_ids corresponding to the items described in the project(s) identified in the purchase request. According to an embodiment of the present invention, item_ids determinator module 1306 may use project_id to item_id mapping information 1314-d to determine the item_ids for pre-mapped projects. According to an embodiment of the present invention, item_ids determinator module 1306 performs processing performed in step 1006 in FIG. 10. Information related to item_ids determined by item_ids determinator module 1306 may then be forwarded to scaler/aggregator module 1308 for further processing.

Scaler/aggregator module 1308 may be configured to perform scaling (both inter-project and intra-project) and aggregation functions. Scaler/aggregator module 1306 may use scaling rules 1314-b to scale items for a project. Scaler/aggregator module 1306 may also performed inter and/or intra project aggregation of the item quantities. According to an embodiment of the present invention, scaler/aggregator module 1306 performs processing performed in steps 1008 and 1010 in FIG. 10.

Purchase units determinator module 1310 may be configured to determine purchasable units information corresponding to the item_ids determined by item_ids determinator module 1306. Purchase units determinator module 1310 may use item_ids to purchasable units mapping information 1314-c to determine the purchasable units corresponding to the item_ids. According to an embodiment of the present invention, purchasable units determinator module 1310 performs processing performed in step 1012 in FIG. 10.

According to an embodiment of the present invention, the purchasable units information determined by purchase units determinator module 1310 may be forwarded to communication module 1302 for communication to the source of the purchase request (e.g. for communication to a user system). According to an alternative embodiment of the present invention, purchase units determinator module 1310 may forward the purchasable units information to user/provider preferences/rules application module 1312 for further processing.

User/provider preferences/rules application module 1312 may be configured to further process the list of purchasable units determined by purchase units determinator module 1310 based on user preferences 1314-e and/or upon rules or preferences 1314-f established by the providers of SSPS 110. The processed purchasable units information may then be forwarded to communication module 1302 for communication to the source of the purchase request. According to an embodiment of the present invention, user/provider preferences/rules application module 1312 performs processing performed in step 1014 in FIG. 10.

Database 1314 may serve as a repository for storing information related to processing performed by SSPS 110. For example, taxonomy information 1314-a, scaling rules 1314-b, item_ids to purchasable units mapping information 1314-c, project_id to item_id mapping information 1314-d, user preferences 1314-e, SSPS provider preferences/rules 1314-f, and other information 1314-g related to processing performed by SSPS 110 may be stored in database 1314. Information/data output by a module may be stored in database 1314 before being forwarded to another module for further processing.

As discussed above, the present invention allows a user to purchase items related to a project by simply identifying the project or providing project related information. The present invention automatically determines purchasable units for the items included in the project and provides information related to the purchasable items to the user. The user may then purchase the purchasable units. The present invention thus offers a level of online shopping convenience, flexibility, and configurability heretofore not provided by conventional online shopping systems. The overall online shopping experience of a user is thus enhanced.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments, such as a distributed computer network environment, a single stand-alone computer system environment, or other computing environments. Additionally, although the present invention has been described using a particular series of transactions and steps, it should be apparent to those skilled in the art that the scope of the present invention is not limited to the described series of transactions and steps. The techniques for indexing, searching and data processing in this patent may be substituted or modified to support various performance and/or systems integration requirements, without deviating from the invention.

There is inherent flexibility in creating the logic, system flow, tables, and data structures used for programming the present invention. Data structures and values upon which calculations are performed may be explicit, derived from other data, imported from other sources, or result from program calculations or logical operations, all without departing from the spirit or limiting the scope of the invention.

Further, while the present invention has been described using a particular combination of hardware and software, it should be recognized that other combinations of hardware and software are also within the scope of the present invention. The present invention may be implemented only in hardware or only in software or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A computer-implemented method of purchasing items comprising:
storing first mapping information for a first plurality of items, the first mapping information identifying a first plurality of purchasable units associated with items in the first plurality of items;
receiving a purchase request comprising information related to a first project from a computer system;
determining a second plurality of items from the information related to the first project, the second plurality of items included in the first plurality of items;
determining a second plurality of purchasable units corresponding to the second plurality of items based upon the first mapping information; and
communicating information related to the second plurality of purchasable units to the computer system.

2. The method of claim 1 wherein receiving the purchase request comprising information related to the first project comprises:
accessing a web page displaying the information related to the first project; and
initiating the purchase request using the web page.

3. The method of claim 1 wherein:
the information related to the first project comprises a first project identifier identifying the first project; and
determining the second plurality of items from the information related to the first project comprises:
storing second mapping information for a plurality of project identifiers, the plurality of project identifiers including the first project identifier, the second mapping information associating at least one item from the first plurality of items with each project identifier in the plurality of project identifiers;
based upon the second mapping information, determining items from the first plurality of items associated with the first project identifier; and
including the items associated with the first project identifier in the second plurality of items.

4. The method of claim 1 wherein determining a second plurality of items from the information related to the first project comprises:
storing second mapping information for a first plurality of item descriptors, the second mapping information associating each item descriptor in the first plurality of item descriptors with at least one item from the first plurality of items;
extracting a second plurality of item descriptors from the information related to the first project, the second plurality of item descriptors included in the first plurality of item descriptors; and
determining the second plurality of items corresponding to the second plurality of item descriptors based upon the second mapping information.

5. The method of claim 1 wherein the information related to the first project comprises scaling information for the first project, the method further comprising:
determining, from the information related to the first project, quantities associated with the second plurality of items; and
scaling the quantities associated with the second plurality of items based upon the scaling information for the first project.

6. The method of claim 5 wherein scaling the quantities associated with the second plurality of items comprises:
for each item in the second plurality of items:
determining a first value based on the scaling information; and
multiplying the quantity associated with the item by the first value to determine a scaled quantity for the item.

7. The method of claim 6 wherein determining the second plurality of purchasable units corresponding to the second plurality of items based upon the first mapping information comprises determining items in the second plurality of purchasable items based on the scaled quantities associated with items in the second plurality of items.

8. The method of claim 5 wherein scaling the quantities associated with the second plurality of items comprises:
storing scaling rules indicating rules for scaling quantities associated with items in the second plurality of items; and
for each item in the second plurality of items:
determining a first value based on the scaling information and the scaling rule for the item; and
multiplying the quantity associated with the item by the first value to determine a scaled quantity for the item.

9. The method of claim 1 wherein determining the second plurality of purchasable units corresponding to the second plurality of items based upon the first mapping information comprises:
for each item in the second plurality of items:
based upon the first mapping information, determining purchasable units from the first plurality of purchasable units associated with the item; and
including the purchasable units associated with the item in the second plurality of purchasable units.

10. The method of claim 1 further comprising outputting the information related to the second plurality of purchasable units.

11. The method of claim 10 wherein outputting the information related to the second plurality of purchasable units comprises:
generating a presentation list based upon information related to the second plurality of purchasable units; and
displaying the presentation list.

12. The method of claim 11 wherein the presentation list is generated based upon user preferences.

13. The method of claim 1 wherein the first project is selectable from a group of projects including a recipe for preparing a food dish, a project for building a computer, a project to repair a leaking faucet, and a project to build a house.

14. A computer-implemented method of purchasing items comprising:
storing first mapping information for a first plurality of items, the first mapping information identifying a first plurality of purchasable units corresponding to the first plurality of items;
receiving a purchase request comprising information related to a first project and a second project from a computer system;
determining a second plurality of items from the information related to the first project, the second plurality of items included in the first plurality of items;
determining a third plurality of items from the information related to the second project, the third plurality of items included in the first plurality of items;
determining a fourth plurality of items including items from the second plurality of items and the third plurality of items;
determining a second plurality of purchasable units corresponding to the fourth plurality of items based upon the first mapping information; and
communicating information related to the second plurality of purchasable units to the computer system.

15. The method of claim 14 wherein:
the second plurality of items includes a first item and a first quantity associated with the first item;
the third plurality of items includes the first item and a second quantity associated with the first item; and
determining the fourth plurality of items including items from the second plurality of items and the third plurality of items comprises:
including the first item in the fourth plurality of items; and
associating a third quantity with the first item in the fourth plurality of items, wherein the third quantity is a sum of the first quantity and the second quantity.

16. The method of claim 15 wherein:
the first quantity is associated with a first unit of measure;
the second quantity is associated with a second unit of measure; and
associating the third quantity with the first item in the fourth plurality of items comprises:
if the first unit of measure is different from the second unit of measure, converting the second quantity to a fourth quantity having the first unit of measure; and
determining the third quantity by adding the first quantity and the fourth quantity.

17. A computer-implemented method of purchasing items for a first project comprising:
storing an information model comprising information for a first plurality of items, the information describing attributes of the first plurality of items, substitute items for the first plurality of items, and hierarchical relationships between the items in the first plurality of items,
storing first mapping information for the first plurality of items, the first mapping information identifying a first plurality of purchasable units associated with items in the first plurality of items;
receiving a purchase request comprising information related to the first project from a computer system;
determining a second plurality of items from the information related to the first project, the second plurality of items included in the first plurality of items;
determining a second plurality of purchasable units corresponding to the second plurality of items based upon the information stored by the information model and the first mapping information; and
communicating information related to the second plurality of purchasable units to the computer system.

18. The method of claim 17 wherein determining the second plurality of purchasable units corresponding to the second plurality of items based upon the information stored by the information model and the first mapping information comprises:
determining a substitute item for at least one item in the second plurality of items based upon information stored by the information model;
determining a purchasable unit corresponding to the substitute item based upon the first mapping information; and
including the purchasable unit corresponding to the substitute item in the second plurality of purchasable units.

19. The method of claim 17 wherein the hierarchical relationships between items in the first plurality of items include a first relationship between a first item and a second item from the first plurality of items, the first relationship indicating that the second item is a specialization of the first item.

20. The method of claim 17 wherein the hierarchical relationships between items in the first plurality of items include a first relationship between a first item and a second item from the first plurality of items, the first relationship indicating that the second item is a component of the first item.

21. A computer-implemented method of shopping for a project comprising:
accessing a web page displaying information related to the project;
generating a purchase request based upon the information related to the project;
in response to the purchase request, receiving information related to a plurality of purchasable units, the plurality of purchasable units corresponding to a plurality of items described by the information related to the project; and
selecting at least one purchasable unit from the plurality of purchasable units for purchase.

22. A system for purchasing items comprising:
a first computer system; and
a second computer system coupled to the first computer system;
wherein the second computer system is configured to:
store first mapping information for a first plurality of items, the first mapping information identifying a first plurality of purchasable units associated with items in the first plurality of items;
receive a purchase request comprising information related to a first project from the first computer system;
determine a second plurality of items from the information related to the first project, the second plurality of items included in the first plurality of items;
determine a second plurality of purchasable units corresponding to the second plurality of items based upon the first mapping information; and
communicate information related to the second plurality of purchasable units to the first computer system.

23. The system of claim 22 wherein:
the information related to the first project comprises a first project identifier identifying the first project; and
in order to determine the second plurality of items from the information related to the first project, the second computer system is configured to:
store second mapping information for a plurality of project identifiers, the plurality of project identifiers including the first project identifier, the second mapping information associating at least one item from the first plurality of items with each project identifier in the plurality of project identifiers;
based upon the second mapping information, determine items from the first plurality of items associated with the first project identifier; and
include the items associated with the first project identifier in the second plurality of items.

24. The system of claim 22 wherein in order to determine a second plurality of items from the information related to the first project, the second computer system is configured to:
store second mapping information for a first plurality of item descriptors, the second mapping information associating each item descriptor in the first plurality of item descriptors with at least one item from the first plurality of items;
extract a second plurality of item descriptors from the information related to the first project, the second plurality of item descriptors included in the first plurality of item descriptors; and
determine the second plurality of items corresponding to the second plurality of item descriptors based upon the second mapping information.

25. The system of claim 22 wherein the information related to the first project comprises scaling information for the first project, and the second computer system is further configured to:
determine, from the information related to the first project, quantities associated with the second plurality of items; and
scale the quantities associated with the second plurality of items based upon the scaling information for the first project.

26. The system of claim 25 wherein in order to scale the quantities associated with the second plurality of items, the second computer system is configured to:
for each item in the second plurality of items:
determine a first value based on the scaling information; and
multiply the quantity associated with the item by the first value to determine a scaled quantity for the item.

27. The system of claim 26 wherein in order to determine the second plurality of purchasable units corresponding to the second plurality of items based upon the first mapping information, the second computer system is configured to determine items in the second plurality of purchasable items based on the scaled quantities associated with items in the second plurality of items.

28. The system of claim 25 wherein in order to scale the quantities associated with the second plurality of items, the second computer system is configured to:
store scaling rules indicating rules for scaling quantities associated with items in the second plurality of items; and
for each item in the second plurality of items:
determine a first value based on the scaling information and the scaling rule for the item; and
multiply the quantity associated with the item by the first value to determine a scaled quantity for the item.

29. The system of claim 22 wherein in order to determine the second plurality of purchasable units corresponding to the second plurality of items based upon the first mapping information, the second computer system is configured to:
for each item in the second plurality of items:
based upon the first mapping information, determine purchasable units from the first plurality of purchasable units associated with the item; and
include the purchasable units associated with the item in the second plurality of purchasable units.

30. The system of claim 22 wherein the first computer system is configured to output the information related to the second plurality of purchasable units received from the second computer system.

31. A data-processing system for purchasing items comprising:
a storage device; and
a processor coupled to the storage device,
the storage device storing a program for controlling the processor, and
the processor operative with the program to:
receive a purchase request comprising information related to a first project and a second project from a computer system;
determine a second plurality of items from the information related to the first project, the second plurality of items included in the first plurality of items;
determine a third plurality of items from the information related to the second project, the third plurality of items included in the first plurality of items;
determine a fourth plurality of items including items from the second plurality of items and the third plurality of items;
determine a second plurality of purchasable units corresponding to the fourth plurality of items based upon the first mapping information; and
communicate the information related to the second plurality of purchasable units to the computer system.

32. The system of claim 31 wherein:
the second plurality of items includes a first item and a first quantity associated with the first item;
the third plurality of items includes the first item and a second quantity associated with the first item; and
in order to determine the fourth plurality of items including items from the second plurality of items and the third plurality of items, the processor is further operative with the program to:
include the first item in the fourth plurality of items; and
associate a third quantity with the first item in the fourth plurality of items, wherein the third quantity is a sum of the first quantity and the second quantity.

33. The system of claim 32 wherein:
the first quantity is associated with a first unit of measure;
the second quantity is associated with a second unit of measure; and
in order to associate the third quantity with the first item in the fourth plurality of items, the processor is further operative with the program to:
if the first unit of measure is different from the second unit of measure, convert the second quantity to a fourth quantity having the first unit of measure; and
determine the third quantity by adding the first quantity and the fourth quantity.

34. An apparatus for purchasing items for a first project comprising:
a processor;
a memory coupled to the processor, the memory configured to store:
an information model comprising information for a first plurality of items, the information describing attributes of the first plurality of items, substitute items for the first plurality of items, and hierarchical relationships between the items in the first plurality of items,
first mapping information for the first plurality of items, the first mapping information identifying a first plurality of purchasable units associated with items in the first plurality of items; and
a plurality of code modules for execution by the processor, the plurality of code modules comprising:
a code module for receiving a purchase request comprising information related to the first project from a first computer system;
a code module for determining a second plurality of items from the information related to the first project, the second plurality of items included in the first plurality of items;
a code module for determining a second plurality of purchasable units corresponding to the second plurality of items based upon the information stored by the information model and the first mapping information; and
a code module for communicating information related to the second plurality of purchasable units to the first computer system.

35. The system of claim 34 wherein the code module for determining the second plurality of purchasable units corresponding to the second plurality of items based upon the information stored by the information model and the first mapping information comprises:
a code module for determining a substitute item for at least one item in the second plurality of items based upon information stored by the information model;
a code module for determining a purchasable unit corresponding to the substitute item based upon the first mapping information; and
a code module for including the purchasable unit corresponding to the substitute item in the second plurality of purchasable units.

36. The system of claim 34 wherein the hierarchical relationships between items in the first plurality of items include a first relationship between a first item and a second item from the first plurality of items, the first relationship indicating that the second item is a specialization of the first item.

37. The system of claim 34 wherein the hierarchical relationships between items in the first plurality of items include a first relationship between a first item and a second item from the first plurality of items, the first relationship indicating that the second item is a component of the first item.

38. A data-processing system for shopping for a project comprising:
a processor;
a memory coupled to the processor, the memory configured to store a plurality of code modules for execution by the processor, the plurality of code modules comprising:
a code module for accessing a web page displaying information related to the project;
a code module for generating a purchase request based upon the information related to the project;
in response to the purchase request, a code module for receiving information related to a plurality of purchasable units, the plurality of purchasable units corresponding to a plurality of items described by the information related to the project; and
a code module for selecting at least one purchasable unit from the plurality of purchasable units for purchase.

39. A computer program product stored on a computer-readable storage medium for purchasing items, the computer program product comprising:
code for storing first mapping information for a first plurality of items, the first mapping information identifying a first plurality of purchasable units associated with items in the first plurality of items;
code for receiving a purchase request comprising information related to a first project from a computer system;
code for determining a second plurality of items from the information related to the first project, the second plurality of items included in the first plurality of items;
code for determining a second plurality of purchasable units corresponding to the second plurality of items based upon the first mapping information; and
code for communicating outputting information related to the second plurality of purchasable units to the computer system.

40. The computer program product of claim 39 wherein the code for receiving the purchase request comprising information related to the first project comprises:
code for accessing a web page displaying the information related to the first project; and
code for initiating the purchase request using the web page.

41. The computer program product of claim 39 wherein:
the information related to the first project comprises a first project identifier identifying the first project; and
the code for determining the second plurality of items from the information related to the first project comprises:
code for storing second mapping information for a plurality of project identifiers, the plurality of project identifiers including the first project identifier, the second mapping information associating at least one item from the first plurality of items with each project identifier in the plurality of project identifiers;
based upon the second mapping information, code for determining items from the first plurality of items associated with the first project identifier; and
code for including the items associated with the first project identifier in the second plurality of items.

42. The computer program product of claim 39 wherein the code for determining a second plurality of items from the information related to the first project comprises:
code for storing second mapping information for a first plurality of item descriptors, the second mapping information associating each item descriptor in the first plurality of item descriptors with at least one item from the first plurality of items;
code for extracting a second plurality of item descriptors from the information related to the first project, the second plurality of item descriptors included in the first plurality of item descriptors; and
code for determining the second plurality of items corresponding to the second plurality of item descriptors based upon the second mapping information.

43. The computer program product of claim 39 wherein the information related to the first project comprises scaling information for the first project, the computer program product further comprising:
code for determining, from the information related to the first project, quantities associated with the second plurality of items; and
code for scaling the quantities associated with the second plurality of items based upon the scaling information for the first project.

44. The computer program product of claim 43 wherein the code for scaling the quantities associated with the second plurality of items comprises:
for each item in the second plurality of items:
code for determining a first value based on the scaling information; and
code for multiplying the quantity associated with the item by the first value to determine a scaled quantity for the item.

45. The computer program product of claim 44 wherein the code for determining the second plurality of purchasable units corresponding to the second plurality of items based upon the first mapping information comprises code for determining items in the second plurality of purchasable items based on the scaled quantities associated with items in the second plurality of items.

46. The computer program product of claim 43 wherein the code for scaling the quantities associated with the second plurality of items comprises:
code for storing scaling rules indicating rules for scaling quantities associated with items in the second plurality of items; and
for each item in the second plurality of items:
code for determining a first value based on the scaling information and the scaling rule for the item; and
code for multiplying the quantity associated with the item by the first value to determine a scaled quantity for the item.

47. The computer program product of claim 39 wherein the code for determining the second plurality of purchasable units corresponding to the second plurality of items based upon the first mapping information comprises:
for each item in the second plurality of items:
based upon the first mapping information, code for determining purchasable units from the first plurality of purchasable units associated with the item; and
code for including the purchasable units associated with the item in the second plurality of purchasable units.

48. The computer program product of claim 39 further comprising code for outputting the information related to the second plurality of purchasable units.

49. The computer program product of claim 48 wherein the code for outputting the information related to the second plurality of purchasable units comprises:
code for generating a presentation list based upon information related to the second plurality of purchasable units; and
code for displaying the presentation list.

50. The computer program product of claim 49 wherein the presentation list is generated based upon user preferences.

51. A computer program product stored on a computer-readable storage medium for purchasing items, the computer program product comprising:
code for storing first mapping information for a first plurality of items, the first mapping information identifying a first plurality of purchasable units corresponding to the first plurality of items;
code for receiving a purchase request comprising information related to a first project and a second project from a computer system;
code for determining a second plurality of items from the information related to the first project, the second plurality of items included in the first plurality of items;
code for determining a third plurality of items from the information related to the second project, the third plurality of items included in the first plurality of items;
code for determining a fourth plurality of items including items from the second plurality of items and the third plurality of items;
code for determining a second plurality of purchasable units corresponding to the fourth plurality of items based upon the first mapping information; and
code for communicating information related to the second plurality of purchasable units to the computer system.

52. The computer program product of claim 51 wherein:
the second plurality of items includes a first item and a first quantity associated with the first item;
the third plurality of items includes the first item and a second quantity associated with the first item; and
the code for determining the fourth plurality of items including items from the second plurality of items and the third plurality of items comprises:
code for including the first item in the fourth plurality of items; and
code for associating a third quantity with the first item in the fourth plurality of items, wherein the third quantity is a sum of the first quantity and the second quantity.

53. The computer program product of claim 52 wherein:
the first quantity is associated with a first unit of measure;
the second quantity is associated with a second unit of measure; and
the code for associating the third quantity with the first item in the fourth plurality of items comprises:
if the first unit of measure is different from the second unit of measure, code for converting the second quantity to a fourth quantity having the first unit of measure; and
code for determining the third quantity by adding the first quantity and the fourth quantity.

54. A computer program product stored on a computer-readable storage medium for purchasing items for a first project, the computer program product comprising:
code for storing an information model comprising information for a first plurality of items, the information describing attributes of the first plurality of items, substitute items for the first plurality of items, and hierarchical relationships between the items in the first plurality of items,
code for storing first mapping information for the first plurality of items, the first mapping information identifying a first plurality of purchasable units associated with items in the first plurality of items;
code for receiving a purchase request comprising information related to the first project from a first computer system;
code for determining a second plurality of items from the information related to the first project, the second plurality of items included in the first plurality of items;
code for determining a second plurality of purchasable units corresponding to the second plurality of items based upon the information stored by the information model and the first mapping information; and
code for communicating information related to the second plurality of purchasable units to the first computer system.

55. The computer program product of claim 54 wherein the code for determining the second plurality of purchasable units corresponding to the second plurality of items based upon the information stored by the information model and the first mapping information comprises:
code for determining a substitute item for at least one item in the second plurality of items based upon information stored by the information model;
code for determining a purchasable unit corresponding to the substitute item based upon the first mapping information; and
code for including the purchasable unit corresponding to the substitute item in the second plurality of purchasable units.

56. The computer program product of claim 54 wherein the hierarchical relationships between items in the first plurality of items include a first relationship between a first item and a second item from the first plurality of items, the first relationship indicating that the second item is a specialization of the first item.

57. The computer program product of claim 54 wherein the hierarchical relationships between items in the first plurality of items include a first relationship between a first item and a second item from the first plurality of items, the first relationship indicating that the second item is a component of the first item.

58. A computer program product stored on a computer-readable storage medium for shopping for a project comprising:
code for accessing a web page displaying information related to the project;
code for generating a purchase request based upon the information related to the project;
in response to the purchase request, code for receiving information related to a plurality of purchasable units, the plurality of purchasable units corresponding to a plurality of items described by the information related to the project; and
code for selecting at least one purchasable unit from the plurality of purchasable units for purchase.
